(19) United States
(12) Patent Application Publication
(10) Pub. No.: US 2018/0043719 A1
(43) Pub. Date: Feb. 15, 2018

(54) IMAGE RECEIVING SHEET

(71) Applicant: FUJIFILM CORPORATION, Tokyo (JP)

(72) Inventors: Yuki TESHIMA, Shizuoka (JP); Kazuhito MIYAKE, Shizuoka (JP)

(21) Appl. No.: 15/798,404

(22) Filed: Oct. 31, 2017

Related U.S. Application Data
(63) Continuation of application No. PCT/JP2016/066476, filed on Jun. 2, 2016.

(30) Foreign Application Priority Data
Jun. 2, 2015 (JP) 2015-112629

(51) Int. Cl. B41M 5/52; G03G 7/00

(52) U.S. Cl. CPC B41M 5/52; G03G 7/0026

(57) ABSTRACT

An image receiving sheet includes an image receiving layer including a resin and having a thickness of 1 μm or greater; and an antistatic layer being the outermost layer, including a resin and at least one conductive material selected from conductive particles and a conductive polymer and having a thickness smaller than that of the image receiving layer, on at least one surface of a support, in an order from the support side.

### CROSS-REFERENCE TO RELATED APPLICATIONS

This application is a continuation application of International Application No. PCT/JP2016/066476, filed Jun. 2, 2016, the disclosure of which is incorporated herein by reference in its entirety. Further, this application claims priority from Japanese Patent Application No. 2015-112629, filed Jun. 2, 2015, the disclosure of which is incorporated herein by reference in its entirety.

### BACKGROUND OF THE INVENTION

### 1. Field of the Invention

The present invention relates to an image receiving sheet.

### 2. Description of the Related Art

In recent years, according to the spread of electrophotographic copying machines and various printers, a full color image with high quality is widely obtained by forming an image on an image receiving sheet (hereinafter, also simply referred to as “image receiving sheet” or “sheet” in some cases) such as coated paper and transparent film coated with an image receiving layer including a resin.

For example, a method of forming a toner image on a transparent film and setting the image as a projected image (transparent image) by an overhead projector (OHP) is widely used as a method of simply obtaining a projected image.

In a case where an electrophotographic image receiving sheet such as a transparent film is loaded in a paper feeding tray of an electrophotographic copying machine and copying is performed, particularly in a case where the image receiving sheet is fed out from the paper feeding tray, multi feed (a phenomenon in which a plurality of films are transported at the same time), oblique transportation, or misfeed (a phenomenon in which a film is not transported) occurs in some cases. In order to prevent these troubles, in addition to the transporting properties (that is, running performances) in a case where a toner image is formed on the surface of the image receiving sheet by a copying machine, hardness (that is, fixing properties) in peeling a toner image formed on the surface of the image receiving sheet is required for the electrophotographic image receiving sheet.

For the purpose of the improvement of the transporting properties and the fixing properties of the image receiving sheet, various kinds of image receiving sheets are suggested in the related art.

For example, JP1999-84707A (JP-H11-84707A) discloses an electrophotographic transferred film provided with an conductive undercoat consisting of conductive particles and a resin material and an image receiving layer consisting of conductive particles and a thermoplastic resin and existing in a state in which conductive particles protrude from a surface in the range of 20 to 5,000 particles per 1 cm² on at least one surface of the support in this order.

JP1995-69627B (JP-H07-69627B) discloses an electrophotographic transparent film in which a toner fixation layer including 25 to 90 mass % of a resin consisting of one or two or more components selected from acrylic acid ester, methacrylic acid ester, a styrene-acrylic acid ester copolymer, a styrene-methacrylic acid ester copolymer, polyvinyl butyral, and a polyester resin, 10 to 75 mass % of a composite of silica sol having an average particle diameter of 3 to 100 μm and/or silica sol having a Si—O—R (R: resin components) bond and a resin component, and 0.05 to 5 mass % of a lubricity imparting agent is provided in a thickness of 1 μm to 10 μm on at least one surface of a heat resistant transparent plastic film of polyethylene terephthalate, polycarbonate, and cellulose triacetate, a kinetic friction coefficient (according to the measurement method regulated in ASTMD 1894) μK in a case where a front surface and a back surface of the film are overlapped is 0.55 or less, and a surface specific resistance value of the toner fixation layer is 10⁹ to 10¹⁴.

JP2006-276841A discloses an electrophotographic recording material obtained by providing a toner fixation layer containing tin oxide on at least one surface of a plastic film, in which stannic oxide is used as tin oxide, a surface of the toner fixation layer under conditions of a temperature of 23° C. and relative humidity of 50% has a surface specific resistance value A (Ω)) in a range of 1×10⁹ to 1×10¹⁴ Ω, and a ratio (B/A) of this and a volume resistivity value B (Ω·cm) of the recording material under conditions of a temperature of 23° C. and relative humidity of 50% is adjusted in the range of 1×10² to 1×10⁵.

### SUMMARY OF THE INVENTION

In recent years, on-demand printing machines have developed, machines that can perform high speed printing increase. Particularly, in a case where electrophotographic printing is performed at high speed, there have been problems in that the fixing power of a toner image formed on the electrophotographic image receiving sheet is small, and the electrophotographic image receiving sheets discharged from the printing machine and stacked are bonded together and are hard to peel off. Even in the case of performing high speed printing by the ink jet method, ink jet image receiving sheets discharged from the printing machine and stacked are bonded to each other and are hard to peel off in some cases. (Hereinafter, the properties of suppressing the bonding between the image receiving sheets which are discharged from the printing machine and stacked may be referred to as “accumulation properties”. Printing machines include printing machines such as electrophotographic printing machines and ink jet printing machines.)

For example, it is considered that the cause of the decrease in the accumulation properties in electrophotographic printing is that the charge amount due to high speed transportation is increased and the bonding due to static electricity becomes strong. Therefore, it is conceivable to reduce the surface resistivity by increasing the content of the conductive material in the image receiving layer. On the other hand, in order to improve the fixing properties of the toner image at high speed printing, it is conceivable to increase the thickness of the image receiving layer such that the toner is sufficiently embedded in the image receiving layer.

However, in a case where the amount of the conductive material in the image receiving layer is increased such that the surface resistivity is suppressed to be low and the thickness of the image receiving layer is increased, the content of the conductive material in the entire image receiving layer is further increased. As the content of the conductive material in the image receiving layer increases, the haze increases or the tint increases. Therefore, for example, even in a case where an image receiving layer is formed on a transparent support, the image receiving sheet becomes unsuitable for the purpose of OHP.

In the image receiving sheets such as an electrophotographic transferred film disclosed in JP1999-84707A (JP-H11-84707A), JP1995-69627B (JP-H07-69627B), or JP2006-276841A, it is considered that the fixing properties of the toner image and the accumulation properties of the image receiving sheet particularly in a case where image formation is continuously performed by high speed printing are not considered, and the antistatic properties are insufficient.

The present invention is conceived considering the above circumstances, and the embodiment according to the present invention provides an image receiving sheet in which, fixing properties of the image are excellent even in a case of high speed printing, and bonding between stacked sheets is suppressed.

In order to achieve the above objects, the present invention includes the following embodiments.
<1> An image receiving sheet comprising, on at least one surface of a support, in an order from the support side:
   an image receiving layer including a resin and having a thickness of 1 μm or greater; and
   an antistatic layer being the outermost layer, including a resin and at least one conductive material selected from conductive particles and a conductive polymer as the outermost layer and having a thickness smaller than that of the image receiving layer.
<2> The image receiving sheet according to <1>, in which the image receiving layer and the antistatic layer each include at least one resin selected from an acrylic resin, a urethane resin, a polyester resin, and a polyolefin resin as the resin and have a crosslinking structure derived from at least one crosslinking agent selected from an oxazoline crosslinking agent, an epoxy crosslinking agent, a carbodiimide crosslinking agent, and an isocyanate crosslinking agent.
<3> The image receiving sheet according to <1> or <2>, in which the antistatic layer includes at least a polyolefin resin as the resin, and a content of the polyolefin resin is the largest among the resins included in the antistatic layer.
<4> The image receiving sheet according to any one of <1> to <3>, in which surface resistivity on a side including the image receiving layer and the antistatic layer is 10⁷ to 10¹⁰ Ω/sq.
<5> The image receiving sheet according to any one of <1> to <4>, in which a thickness of the image receiving layer is 1 to 10 μm, and a thickness of the antistatic layer is 0.01 to 1 μm.
<6> The image receiving sheet according to any one of <1> to <5>, in which the support is a polyethylene terephthalate film.
<7> The image receiving sheet according to any one of <1> to <6>, in which the antistatic layer includes acicular particles obtained by doping SnO₂ with Sb as the conductive material.
<8> The image receiving sheet according to any one of <1> to <7>, in which the image receiving layer does not include the conductive material, or a content of the conductive material included per unit volume of the image receiving layer is smaller than that of the conductive material included per unit volume of the antistatic layer.
<9> The image receiving sheet according to any one of <1> to <8> which is used for electrophotography.
<10> The image receiving sheet according to any one of <1> to <8> which is used for ink jet printing.

The embodiment according to the present invention provides an image receiving sheet in which, fixing properties of the image are excellent even in a case of high speed printing, and bonding between stacked sheets is suppressed.

### BRIEF DESCRIPTION OF THE DRAWINGS

FIG. 1 is a schematic view illustrating an example of a layer configuration of an electrophotographic image receiving sheet according to a present embodiment.

FIG. 2 is a schematic view illustrating another example of the layer configuration of the electrophotographic image receiving sheet according to the present embodiment.

FIG. 3 is a schematic view illustrating another example of the layer configuration of the electrophotographic image receiving sheet of the present embodiment.

### DESCRIPTION OF THE PREFERRED EMBODIMENTS

Hereinafter, the embodiment according to the present invention is described with reference to the accompanying drawings. Each of the referred accompanying drawings illustrates an example of an electrophotographic image receiving sheet, but the image receiving sheet of the present embodiment is not limited to the electrophotographic image receiving sheet. The constituent elements shown with the same reference numerals in each of the drawings mean the same constituent elements. Duplicated explanations and reference symbols in the embodiments described below may be omitted.

In the following description, “to” representing a numerical range means a range including numerical values described as a lower limit value and an upper limit value. In the case where a unit is attached only to the upper limit value, the lower limit value is also defined by the same unit.

### [Image Receiving Sheet]

The image receiving sheet of the present embodiment includes an image receiving layer including a resin and having a thickness of 1 μm or greater and an antistatic layer including a resin and at least one conductive material selected from conductive particles and a conductive polymer, and having smaller thickness than that of the image receiving layer, as an outermost layer on at least one surface of the support (hereinafter, also referred to as a “surface” or a “first surface”), in an order from the support side. According to the image receiving sheet of the present embodiment, even in a case where high speed printing is performed, an image receiving sheet in which fixing properties of an image are excellent and bonding between stacked sheets is suppressed is provided.

The image receiving sheet of the present embodiment is suitably used for electrophotography and for ink jet printing.

That is, according to an embodiment of the present invention, even in a case where the high speed printing is performed, an electrophotographic image receiving sheet in which fixing properties of a toner image are excellent and bonding due to static electricity between stacked sheets is suppressed is provided.

According to another embodiment of the present invention, in a case where high speed printing is performed by an ink jet method, particularly even in a case where printing is performed by using aqueous ink, an ink jet image receiving sheet in which fixing properties of an image is excellent, and bonding due to static electricity between stacked sheets is suppressed is provided.

In order to obtain high fixing properties in the high speed printing (for example, the number of prints is 50 sheets/min or greater), it is required to provide a resin layer having a thickness of 1 μm or greater on the support. Therefore, in a case where a double layer configuration having a total thickness is 1 μm or greater is obtained, for example, by providing the resin layer on the support and further providing the image receiving layer including a conductive material and having a greater thickness than that of the resin layer on the resin layer, improvement of accumulation properties or fixing properties of a toner or ink can be expected to some extent. However, in this case, in order to secure a contact between conductive materials in a thick image receiving layer, as the thickness of the image receiving layer becomes greater, a required amount of the conductive material becomes greater.

In contrast, in the image receiving sheet of the present embodiment, it is possible to increase the thickness by providing the image receiving layer having a thickness of 1 μm or more on the side close to the support, and thus, for example, in a case of high speed printing, it is possible to obtain high fixing properties of a toner or ink. Meanwhile, since a conductive material is included in an antistatic layer having a smaller thickness than that of the image receiving layer as the outermost layer, contact between the conductive materials is secured even with a relatively small amount of conductive material. Therefore, the surface resistivity is effectively lowered, and thus the accumulation properties can be improved.

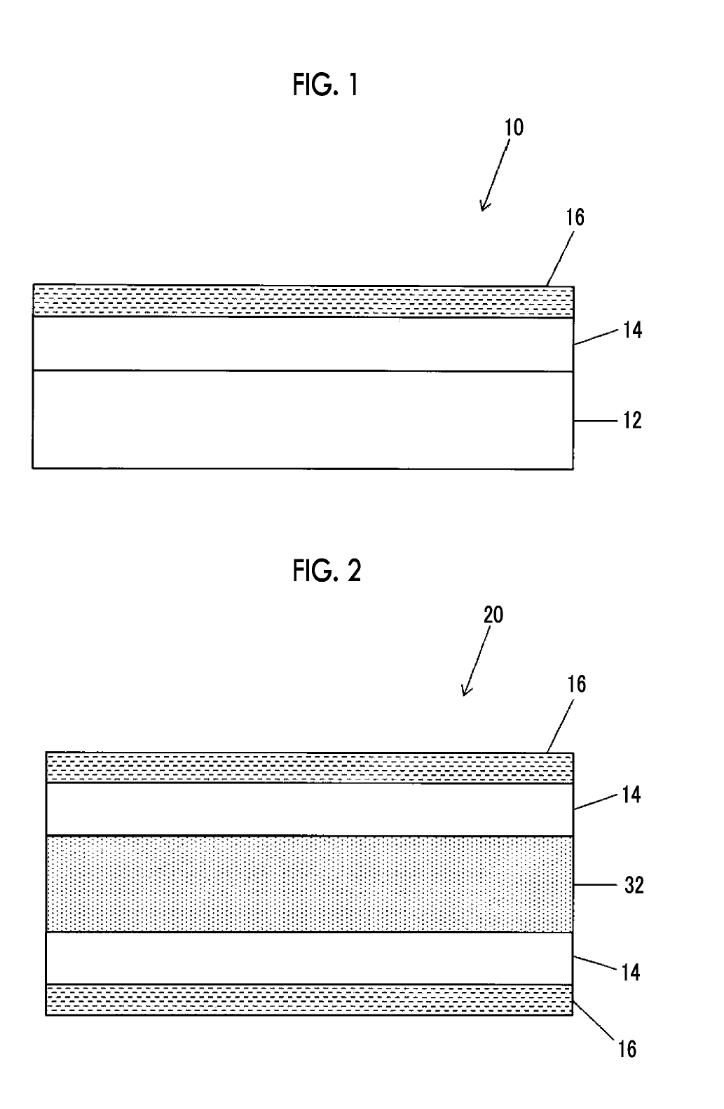

FIG. 1 schematically illustrates an example (a first embodiment) of a layer configuration of an electrophotographic image receiving sheet according to one of the present embodiment. In an electrophotographic image receiving sheet 10 illustrated in FIG. 1, an image receiving layer 14 and an antistatic layer 16 are laminated on one surface (first surface) of a support 12. The image receiving layer 14 includes a resin and has a thickness of 1 μm or greater. The antistatic layer 16 has thinner thickness than that of the image receiving layer 14 and includes a resin and at least one conductive material selected from conductive particles and a conductive polymer.

FIG. 2 schematically illustrates an example (a second embodiment) of a layer configuration of the electrophotographic image receiving sheet which is one of the present embodiment. In an electrophotographic image receiving sheet 20 illustrated in FIG. 2, the image receiving layer 14 and the antistatic layer 16 are laminated on both surfaces of a support 32, from the support 32 side. In a case where an electrophotographic image receiving sheet that can be used in double-sided printing by providing the image receiving layer 14 and the antistatic layer 16 on both surfaces of the support 32, in order to suppress the image formed on each surface from permeating to the opposite side, it is preferable to use a support having low light transmittance such as a white support 32.

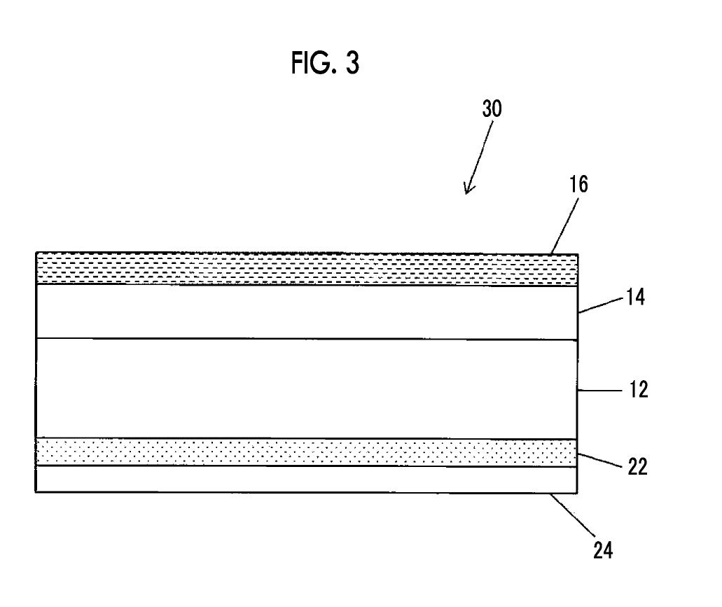

FIG. 3 schematically illustrates an example (a third embodiment) of the layer configuration of the electrophotographic image receiving sheet which is one of the present embodiment. In an electrophotographic image receiving sheet 30 illustrated in FIG. 3, the image receiving layer 14 and the antistatic layer 16 are laminated from the support 12, on one surface (first surface) of the support 12, a back surface side antistatic layer 22 including a resin and a conductive material and a back surface side flattening layer 24 including a resin are laminated from the support 12 side on the other surface (the second surface).

Hereinafter, respective configurations are specifically described.

### <Support>

As the support, paper, water resistant paper obtained by applying or laminating a resin on paper, a cloth foil, a resin film, or the like can be used.

Particularly, in a case where a water resistant base material including a resin layer such as a resin film or water resistant paper is the support, there is tendency in that the base material is easily charged and the accumulation properties decrease. However, according to the present embodiment, in a case where the image receiving layer and the antistatic layer are provided, charging is effectively suppressed, and the accumulation properties can be remarkably improved.

In a case where the electrophotographic image receiving sheet according to the present embodiment, for example, is used as an OHP film, a resin film that is transparent and has properties of being resistant to heat applied in a case of fixing the toner image (hereinafter, sometimes simply referred to as a “film”) can be suitably used as the support.

With respect to the ink jet printing image receiving sheet the present embodiment, a resin film can be suitably used as the support.

Specific materials forming the resin film include polyesters such as polyethylene terephthalate and polyethylene naphthalate; cellulose esters such as nitrocellulose, cellulose acetate, and cellulose acetate butyrate, polysulfone, polyphenylene oxide, polyimide, polycarbonate, and polyamide. In view of excellent heat resistance and excellent transparency, a polyethylene terephthalate film (hereinafter, also referred to as a “PET film” in some cases) is preferable.

The thickness of the support is not particularly limited. However, a support having a thickness of 50 to 300 μm can be easily handled and is preferable.

For example, in a case where a resin film is used as the support, the thickness thereof preferably is a thickness in which wrinkles do not easily occur in a case where the resin film is softened by heating in a case of fixing the toner image, and specifically the thickness is preferably 50 μm or greater and more preferably 75 μm or greater. Considering to maintain high transporting properties due to flexibility, and the like, the upper limit of the thickness of the resin film is preferably 300 μm or less and more preferably 250 μm or less.

The support does not have to be transparent and may be a white support, for example. For example, it is possible to use a white resin film including white particles such as titanium oxide and barium sulfate. A resin film that generates voids and becomes white can be used.

The method for preparing the support is not particularly limited. In the case where, for example, a resin film is used as the support, an un-stretched film, a uniaxially stretched film or a biaxially stretched film can be suitably used.

### <Image Receiving Layer>

The image receiving layer is formed to include at least a resin on at least one surface of the support and has a thickness of 1 μm or greater.

The “image receiving layer” in the present specification means a layer disposed between a support and an antistatic layer on a side on which an image (including a toner image or an ink jet image) is formed in the image receiving sheet. The image receiving layer disposed between the support and the antistatic layer may be a single layer or may be obtained by laminating two or more layers.

In a case where the image receiving layer is obtained by laminating two or more layers, the layers forming the image receiving layer may have the same composition or may have different compositions.

### (Resin)

The resin included in the image receiving layer is preferably a thermoplastic resin. Examples thereof include a polyolefin resin, a polyester resin, a polyether resin, an acrylic resin, an epoxy resin, a urethane resin, an amino resin, and a phenol resin, in view of close attachment between the support and the antistatic layer. The image receiving layer preferably includes at least one resin selected from an acrylic resin, a urethane resin, a polyester resin, and a polyolefin resin.

In view of close attachment between the support and the antistatic layer, the content of the resin in the image receiving layer is preferably 50 to 95 mass %, more preferably 55 to 90 mass %, and even more preferably 60 to 90 mass % with respect to the total mass of the image receiving layer. The image receiving layer may include a plurality of kinds of resins. In a case where the image receiving layer includes a plurality of kinds of resins, the total content of the resin is preferably in the above range.

The image receiving layer preferably includes a polyolefin resin as a primary resin and more preferably includes an acrylic resin as a secondary resin. In the present specification, the expression “primary resin” means a resin of which the content in terms of mass in the resin included in a specific layer is the most, and the “secondary resin” means a resin of which the content in terms of mass in the resin included in the specific layer is the second most.

In a case where the image receiving layer includes polyolefin as the primary resin, the softening temperature is low, and the toner is easily embedded. In a case where the image receiving layer includes an acrylic resin as the secondary resin, the close attachment force of the toner image can be improved. In a case where the image receiving layer includes a polyolefin resin and an acrylic resin, the content ratio (that is, polyolefin resin:acrylic resin) of these resins is preferably 1:1 to 5:1 and more preferably 1:1 to 4:1.

As the resin included in the image receiving layer, a commercially available product may be used.

Examples of the polyolefin resin include ARROWBASE (registered trademark) SE1013N, SA1200, SB1200, SE1200, and SD1200 (Unitika Ltd.), and CHEMIPERAL (registered trademark) 5120, 5650, S8ON, A100, and V100 (Mitsui Chemicals, Inc.).

Examples of the acrylic resin include AQUABRID (registered trademark) AS563 (Daicell Finechem Ltd.), JURYMER (registered trademark) ET-410 (Toagosei Co., Ltd.), and BONRON (registered trademark) PS002 (Mitsui Chemicals, Inc.).

Examples of the urethane resin include SUPERFLEX (registered trademark) 150HS, 110, and 420 (DKS Co., Ltd.), HYDRAN (registered trademark) HW350 (DIC Corporation), and TAKELAC (registered trademark) WS400 and WS5100 (Mitsui Chemicals, Inc.).

Examples of the polyester resin include PESRESIN (registered trademark) A520 and A615GW (Takamatsu Oil & Fat Co., Ltd.), VYLONAL (registered trademark) MD1200 and MD1245 (Toyobo Co., Ltd.), FINETEX (registered trademark) ES650 and ES2200 (DIC Corporation), and PLASCOAT (registered trademark) Z687 and Z592 (Goo Chemical Co., Ltd.).

### (Crosslinking Agent)

In view of water resistance, the image receiving layer preferably has a crosslinking structure derived from a crosslinking agent and particularly preferably has a crosslinking structure derived from at least one crosslinking agent selected from an oxazoline crosslinking agent, an epoxy crosslinking agent, a carbodiimide crosslinking agent, and an isocyanate crosslinking agent.

Examples of the oxazoline crosslinking agent include EPOCROS (registered trademark) WS700, WS300, K2010E, K2020E, and K2030E (Nippon Shokubai Co., Ltd.).

Examples of the epoxy crosslinking agent include DENACOL (registered trademark) EX614B and EX521 (Nagase ChemteX Corporation).

Examples of the carbodiimide crosslinking agent include CARBODILITE (registered trademark) V02, V02L2, SV02, and V10 (Nissinbo Chemical Inc.).

Examples of the isocyanate crosslinking agent include DURANATE (registered trademark) WB40, WT20, and WM44 (Asahi Kasei Chemicals Corporation).

The content of the crosslinking agent included in the coating solution (a coating solution for forming an image receiving layer) for forming the image receiving layer depends on kinds of resins or kinds of crosslinking agents, but is generally 1 to 50 mass % with respect to the total solid content of the image receiving layer.

### (Surfactant)

In order to increase wettability to the support and improving levelability of the coating solution, the image receiving layer may contain a surfactant contained in the coating solution for forming the image receiving layer.

The surfactant may be any one of a cationic surfactant, an anionic surfactant, or a nonionic surfactant. However, examples of the fluorocarbon-based surfactant include SURFLON (registered trademark) S231W (AGC Seimi Chemical Co., Ltd.) and sodium=1.2-{bis(3,3,4,4,5,5,6,6,6-nonafluorohexylcarbonyl)} ethanesulfonate, examples of the anionic surfactant include sulfosuccinates and alkylsulfonates, and examples of the nonionic surfactant include polyoxyethylene alkyl ether.

### (Other Materials)

The image receiving layer may include well-known materials such as a colorant, an ultraviolet absorbing agent, an antioxidant, and a fluorescent whitening agent, in a range of not deteriorating the properties (fixing properties and accumulation properties) of the image receiving sheet, if necessary.

The image receiving layer may include a conductive material described below. However, it is preferable that the content of the conductive material included per unit volume of the image receiving layer is smaller than that of the conductive material per unit volume of the antistatic layer, or it is preferable that the conductive material is not included. Here, the content of the conductive material included per unit volume of the image receiving layer is based on mass and can be adjusted depending on the concentration (based on mass) of the conductive material in a coating solution for forming each of the layers.

### (Thickness)

The thickness of the image receiving layer in the image receiving sheet of the present embodiment is 1 μm or greater. If the image receiving layer has the thickness of 1 μm or greater, for example, in a case where the electrophotographic image receiving sheet or the ink jet printing image receiving sheet is used, a toner transferred to the antistatic layer or ink ejected thereto is easily embedded into the image receiving layer, and can greatly increase fixing properties of the toner image or the ink jet image.

The thickness of the image receiving layer is preferably in the range of 1 to 10 μm and more preferably in the range of 2 to 8 μm. In a case where the thickness of the image receiving layer is 10 μm or less, cohesive failure hardly occurs in the image receiving layer in a case of fixing, and an offset phenomenon hardly occurs.

In a case where the image receiving layer has a configuration of two or more layers between the support and the antistatic layer, the thickness of the entire image receiving layer may be 1 μm or greater and preferably in the range of 1 to 10 μm.

The thickness of each of the layers of the image receiving sheet can be measured by observing a cut surface in the thickness direction with an electron microscope.

### (Method of Forming Image Receiving Layer)

The image receiving layer can be formed by coating at least one surface of the support with a coating solution for forming the image receiving layer obtained by dispersing or dissolving a resin, a crosslinking agent, and a surfactant in water or an organic solvent and performing heating and drying.

The coating solution for forming the image receiving layer may be prepared depending on kinds of the resin or the like for forming the image receiving layer, and an organic solvent or water may be used as the solvent. In view of the reduction of the environmental burden, an emulsion using water as the solvent is preferable.

The method of coating the support with the coating solution for forming the image receiving layer is not particularly limited, and the coating solution for forming the image receiving layer can be applied by using a well-known coating method such as an air doctor coater, a blade coater, a rod coater, a knife coater, a squeeze coater, a reverse roll coater, and a bar coater.

The surface of the support on a side on which the image receiving layer is formed may be preferably subjected to a surface treatment such as a corona discharge treatment, a plasma treatment, a flame treatment, and an ultraviolet irradiation treatment, in order to improve adhesiveness between the support and the image receiving layer.

### <Antistatic Layer>

The antistatic layer includes a resin and at least one conductive material selected from conductive particles and a conductive polymer, and is provided as an outermost layer of the image receiving sheet.

### (Resin)

The resin included in the antistatic layer is preferably a thermoplastic resin and examples thereof include a polyolefin resin, a polyester resin, a polyether resin, an acrylic resin, an epoxy resin, a urethane resin, an amino resin, and a phenol resin.

In view of close attachment of the image receiving layer or the toner, the antistatic layer preferably includes at least one resin selected from an acrylic resin, a urethane resin, a polyester resin, and a polyolefin resin as the resin.

In view of antistatic properties and adhesiveness to the toner, the content of the resin in the antistatic layer is preferably 20 to 95 mass %, more preferably 25 to 90 mass %, and even more preferably 30 to 85 mass % with respect to the total mass of the antistatic layer. The antistatic layer may include a plurality of kinds of resins. In a case where a plurality of kinds of resins are included, the total content of the resin is preferably in the above range.

It is preferable that the antistatic layer includes a polyolefin resin as the primary resin, and it is more preferable that an acrylic resin is included as the secondary resin. In a case where the antistatic layer which is an outermost layer includes a polyolefin resin as the primary resin, improvement of the running performances of the electrophotographic image receiving sheet can be tried.

In a case where the antistatic layer includes a polyolefin resin and an acrylic resin, the content ratio (polyolefin resin:acrylic resin) of these resins is preferably 1:1 to 10:1.

As the resin included in the antistatic layer, a commercially available product may be used.

Examples of the polyolefin resin include ARROWBASE (registered trademark) SE1013N, SA1200, SB1200, SE1200, and SD1200 (Unitika Ltd.) and CHEMIPERAL (registered trademark) 5120, 5650, S8ON, A100, and V100 (Mitsui Chemicals, Inc.).

Examples of the acrylic resin include AQUABRID (registered trademark) AS563 (Daicell Finechem Ltd.), JURYMER (registered trademark) ET-410 (Toagosei Co., Ltd.), and BONRON (registered trademark) PS002 (Mitsui Chemicals, Inc.).

Examples of the urethane resin include SUPERFLEX (registered trademark) 150HS, 110, and 420 (DKS Co., Ltd.), HYDRAN (registered trademark) HW350 (DIC Corporation), and TAKELAC (registered trademark) WS400 and WS5100 (Mitsui Chemicals, Inc.).

Examples of the polyester resin include PESRESIN (registered trademark) A520 and A615GW (Takamatsu Oil & Fat Co., Ltd.), VYLONAL (registered trademark) MD1200 and MD1245 (Toyobo Co., Ltd.), FINETEX (registered trademark) ES650 and ES2200 (DIC Corporation), and PLASCOAT (registered trademark) Z687 and Z592 (Goo Chemical Co., Ltd.).

### (Conductive Material)

The antistatic layer may include a resin and at least one conductive material selected from conductive particles and a conductive polymer.

The conductive material in the antistatic layer may use one conductive material selected from the conductive particles and a conductive polymer singly or two or more kinds thereof may be used in combination. For example, two or more kinds of conductive particles or a conductive polymer may be used in combination, or conductive particles and a conductive polymer may be used in combination.

With respect to the content of the conductive material in the antistatic layer, it is preferable that the conductive material is included such that the surface resistivity becomes a preferable range (10⁷ to 10¹⁰ Ω/sq) described below. The content of the conductive material varies depending on the conductive material, but considering scratch resistance of a film, haze, and the like, in addition to the surface resistivity, the content of the conductive material in the antistatic layer is generally in the range of 5 to 70 mass %.

### Conductive Particles

Examples of the conductive particles that can be used as the conductive material in the antistatic layer include metal oxide, heterogeneous element-containing metal oxide, metal powder, metal fiber, and carbon fiber. Particles (hereinafter, referred to as conductive material coated particles in some cases) coated with the conductive material may be used.

Examples of the metal oxide include ZnO, TiO, SnO₂, Al₂O₃, In₂O₃, SiO₂, MgO, BaO, and MoO₃. The metal oxide may be used singly or composite oxide thereof may be used.

It is preferable that a heterogeneous element is contained in the metal oxide, and it is preferable that Al, In, and the like are contained in ZnO, Nb, Ta, and the like are contained in TiO, and Sb, Nb, a halogen element, and the like are contained in SnO₂. Among these, SnO₂ doped with Sb is particularly preferable.

Examples of the metal powder include powder of Ag, Cu, Ni, Fe, and the like.

Examples of the metal fiber include a steel fiber.

Examples of the scaly metal include a silver foil.

The particles (that is, conductive material coated particles) coated with the conductive material are particles obtained by coating a surface of a core material (that is, core particles) with a conductive coated material, and spherical, acicular, and fibrous particles can be used.

Examples of the core material include metal oxide, whiskers (for example, aluminum borate, potassium titanate, or rutile type titanium oxide), an inorganic fiber (for example, a glass fiber), mica particles, or organic particles.

Examples of the conductive coated material include metal (for example, Ag, Au, Al, Cr, Cd, Ti, Ni, or Fe), conductive metal oxide, and carbon.

Examples of the coating method include a method of causing a conductive material to be attached to a surface of a core particle by plating, a vacuum evaporation method, a mechanochemical method, or the like.

Preferable examples of the conductive material coated particles include conductive particles obtained by coating the surface of the organic particle with the conductive material.

Examples of the method of coating the surface of the organic particle with the conductive material include methods such as plating and mechanochemical method of attaching coating particles of the conductive material to the surface of the core particle of the organic material.

Examples of the organic material forming the organic particles include polyolefin such as polyethylene and polypropylene, starch, polystyrene, a styrene-divinylbenzene copolymer, a melamine resin, an epoxy resin, a phenol resin, and fluororesin. These organic materials may be used singly or two or more kinds thereof may be used in combination.

The conductive material used for coating the surface of the organic particles is preferably a material of which volume resistivity is 1×10⁻⁵ to 1×10⁴ Ω. Examples thereof include metal such as Al, Cr, Cd, Ti, Fe, Cu, Ni, Pd, Pt, Rh, Ag, Au, Ru, W, Sn, Zr, and In; an alloy such as stainless steel, brass, and Ni—Cr; metal oxide such as indium oxide, tin oxide, zinc oxide, titanium oxide, vanadium oxide, ruthenium oxide, and tantalum oxide; and a metal compound such as silver iodide.

Particularly preferable examples of the conductive material coated particles include conductive particles obtained by performing metal plating on the surfaces of organic particles. Here, as the metal, Au, Ni, and Sn are preferable, and Au is particularly preferable.

In the conductive material coated particles, a mass ratio of the organic particles and the conductive material is generally in the range of 1:20 to 20:1 and preferably in the range of 1:5 to 5:1.

The shape of the conductive particles is not particularly limited, and spherical conductive particles, acicular conductive particles, fibrous conductive particles, scaly conductive particles, and the like can be used. In view of easily obtaining a contact between conductive particles, it is preferable to use acicular or fibrous conductive particles. Acicular particles obtained by doping SnO₂ with Sb are particularly preferable.

In view of securing a contact between the conductive particles, the average particle diameter of the conductive particles is preferably greater than a half of a film thickness of the antistatic layer. In view of haze and scratch resistance, the average particle diameter thereof is preferably less than twice of the film thickness of the antistatic layer. In a case where acicular, rod-like, columnar, or fibrous conductive particles are used, an average particle diameter of a short axis and a long axis can be obtained. However, it is preferable that the film thickness of the short axis is less than twice of the film thickness, and the film thickness of the long axis is greater than a half of the film thickness. Here, the average particle diameter is a value obtained by observing and averaging 20 arbitrary particles by electron microscope observation.

As the conductive particles, a commercially available product can be used. For example, acicular metal oxide having a high aspect ratio such as a “TIPAQUE FT” series (Ishihara Sangyo Kaisha, Ltd.) obtained by causing rutile-type acicular TiO₂ to have conductivity, a “TIPAQUE FS” series (Ishihara Sangyo Kaisha, Ltd.) such as FS-10D (aqueous dispersion of acicular Sb doped SnO₂), a “PASTRAN” series (Mitsui Mining & Smelting Co., Ltd.), and “DENTOL BK and WK” series (Otsuka Chemical Co., Ltd.) obtained by causing potassium titanate whisker (K₂O·8TiO₂) to have conductivity can be suitably used. TDL-1 (an aqueous dispersion of granular Sb-doped SnO₂, JEMCO Components & Fabrication, Inc.) and the like can be also suitably used.

### Conductive Polymer

Examples of the conductive polymer that can be used as the conductive material in the antistatic layer include a polyacetylene-based polymer, a polypyrrole-based polymer, a polythiophene-based polymer, and a polyaniline-based polymer.

Examples of the commercially available conductive polymer include Orgacon (registered trademark) HBS (polyethylene dioxythiophene/polystyrene sulfonate, IPROS Corporation).

The conductive polymer may be included in an antistatic layer in a particle form.

### (Crosslinking Agent)

In view of water resistance, the antistatic layer preferably has a crosslinking structure derived from a crosslinking agent, and particularly preferably has a crosslinking structure derived from at least one crosslinking agent selected from an oxazoline crosslinking agent, an epoxy crosslinking agent, a carbodiimide crosslinking agent, and an isocyanate crosslinking agent.

Examples of the oxazoline crosslinking agent include EPOCROS (registered trademark) WS700, WS300, K2010E, K2020E, and K2030E (Nippon Shokubai Co., Ltd.).

Examples of the epoxy crosslinking agent include DENACOL (registered trademark) EX614B and EX521 (Nagase ChemteX Corporation).

Examples of the carbodiimide crosslinking agent include CARBODILITE (registered trademark) V02, V02L2, SV02, and V10 (Nissinbo Chemical Inc.).

Examples of the isocyanate crosslinking agent include DURANATE (registered trademark) WB40, WT20, and WM44 (Asahi Kasei Chemicals Corporation).

The content of the crosslinking agent included in the coating solution (coating solution for forming an antistatic layer) for forming the antistatic layer varies depending on kinds of resins, kinds of crosslinking agents, and the like, but is generally 1 to 50 mass % with respect to the total solid content of the antistatic layer.

### (Surfactant)

The antistatic layer may contain a surfactant contained in the coating solution for forming the antistatic layer used for increasing wettability to the image receiving layer and improving the levelability of the coating solution.

The surfactant may be any one of a cationic surfactant, an anionic surfactant, or a nonionic surfactant, and examples of the fluorine-based surfactant include SURFLON (registered trademark) S231W (AGC Seimi Chemical Co., Ltd.) and sodium=1.2-{bis(3,3,4,4,5,5,6,6,6-nanofluorohexylcarbonyl)} ethanesulfonate, examples of the anionic surfactant include sulfosuccinates or alkylsulfonates, and examples of the nonionic surfactant include polyoxyethylene alkyl ether.

### (Other Materials)

The antistatic layer may include additives such as a releasing agent and a filler.

For example, the releasing agent which may be contained in the antistatic layer can be selected from a silicone compound, a fluorine compound, wax, and a matting agent. As the releasing agent, one kind thereof may be used singly or two or more kinds thereof may be used in combination. Preferable examples thereof include silicone oil, polyethylene wax, carnauba wax, silicone particles, and polyethylene wax particles.

Examples of the filler which may be contained in the antistatic layer include silica, alumina, titanium dioxide, and zirconium oxide. As the filler, silica or alumina is particularly preferable, and colloidal silica is more preferable. As the filler, one kind thereof may be used singly or two or more kinds thereof may be used in combination.

### (Thickness)

The thickness of the antistatic layer is not particularly limited, as long as the thickness of the antistatic layer is smaller than that of the image receiving layer. However, in view of effectively suppressing charging, the thickness thereof is preferably in the range of 0.01 to 1 μm and more preferably in the range of 0.02 to 0.5 μm.

### (Method of Forming Antistatic Layer)

The antistatic layer can be formed, for example, by coating the image receiving layer with an aqueous dispersion liquid (that is, the coating solution for forming the antistatic layer) including the resin, and at least one conductive material selected from the conductive particles and the conductive polymer, the crosslinking agent, and the like and performing heating and drying.

The coating solution for forming the image receiving layer may be prepared depending on the kind of the resin for forming the image receiving layer and the like, and an organic solvent or water may be used as the solvent. In view of the reduction of environmental burden and the like, an emulsion using water as the solvent is preferable.

The coating method of the coating solution for forming the antistatic layer is not particularly limited, and the coating method can be performed by a well-known coating method such as an air doctor coater, a blade coater, a rod coater, a knife coater, a squeeze coater, a reverse roll coater, a wire bar coater, and a bar coater.

The heating and drying may be performed by performing drying preferably at 90° C. to 200° C. for 0.1 to 10 minutes and more preferably 130° C. to 200° C. for 0.5 to 5 minutes, for example, by a hot air dryer.

### <Surface Resistivity>

In the image receiving sheet of the present embodiment, the surface resistivity (hereinafter, referred to as “surface resistivity on an image receiving side” in some cases) on a side on which the image receiving layer and the antistatic layer are included is preferably 10⁷ to 10¹⁰ Ω/sq. In a case where the surface resistivity on the image receiving side is 10⁷ Ω/sq or greater, for example, an image can be formed by an electrophotographic method, and in a case where the surface resistivity is 10¹⁰ Ω/sq or less, accumulation (charging) of the static electricity can be effectively suppressed. In this point of view, the surface resistivity on the image receiving side of the image receiving sheet of the present embodiment is more preferably 10^{7.1} to 10^{9.5} Ω/sq and even more preferably 10^{7.2} to 10^{8.8} Ω/sq.

In a case where the image receiving layer and the antistatic layer are respectively formed on the both surfaces of the support, the surface resistivity of the both surfaces of the image receiving sheet is preferably 10⁷ to 10¹⁰ Ω/sq, more preferably 10^{7.1} to 10^{9.5} Ω/sq, and even more preferably 10^{7.2} to 10^{8.8} Ω/sq.

The surface resistivity (hereinafter, simply referred to as “SR”) of the image receiving sheet according to the present embodiment is a value obtained by applying 100 V by using a digital electrometer (8252, manufactured by ADC Corporation) and RESISTIVITY CHAMBER (12704A, manufactured by ADC Corporation) in the circumstance of 25° C. and 20% RH, and calculating surface resistivity from the current value after 60 seconds.

On the surface (hereinafter, referred to as a “back surface” or a “second surface” in some cases) on a side on which the image receiving layer and the antistatic layer of the support are not provided, as illustrated in FIG. 2, the image receiving layer and the antistatic layer may be provided in the same manner as in the first surface.

In a case where an image is not formed on the back surface side, in the image receiving sheet according to the present invention, a back surface side antistatic layer for preventing charging on the back surface side as illustrated in FIG. 3 and a back surface side flattening layer for flattening the back surface side may be provided.

### <Back Surface Side Antistatic Layer>

The back surface side antistatic layer is a layer in which conductive particles and the like are dispersed in the resin material.

Examples of the conductive particles include metal oxide such as ZnO, TiO, SnO₂, Al₂O₃, In₂O₃, SiO₂, MgO, BaO, and MoO₃. These may be used singly or composite oxide thereof may be used. It is preferable that the metal oxide further contains a heterogeneous element, and, for example, metal oxide obtained by causing ZnO to contain (to be doped with) Al, In, and the like, TiO to contain (to be doped with) Nb, Ta, and the like, and SnO₂ to contain (to be doped with) Sb, Nb, a halogen element, and the like is preferable. Among these, SnO₂ doped with Sb is particularly preferable. The particle diameter of the conductive particles is preferably 0.2 μm or less.

Examples of the resin material of the back surface side antistatic layer include a water soluble resin such as polyvinyl alcohol, polyacrylic acid, polyacrylamide, polyhydroxyethyl acrylate, polyvinyl pyrrolidone, water soluble polyester, water soluble polyurethane, water soluble nylon, a water soluble epoxy resin, gelatin, hydroxyethyl cellulose, hydroxypropyl cellulose, carboxymethyl cellulose and a derivative thereof; a water dispersible resin such as a water dispersed acrylic resin and water dispersed polyester; an acrylic resin emulsion; an emulsion such as a polyvinyl acetate emulsion and a styrene•butadiene•rubber (SBR) emulsion; and an organic solvent soluble resin such as an acrylic resin and a polyester resin.

A water soluble resin, a water-dispersible resin, and an emulsion are preferable.

A surfactant and a matting agent may be further added to these resins, and it is preferable that at least one crosslinking agent selected from an oxazoline crosslinking agent, an epoxy crosslinking agent, a carbodiimide crosslinking agent, and an isocyanate crosslinking agent is further added.

The forming of the back surface side antistatic layer can be performed by coating the back surface of the support with an aqueous dispersion liquid (that is, a coating solution for forming a back surface side antistatic layer) including a resin, a crosslinking agent, and the like, and performing heating and drying.

The coating may be performed by a well-known coating method such as an air doctor coater, a blade coater, a rod coater, a knife coater, a squeeze coater, a reverse roll coater, a wire bar coater, and a bar coater.

The drying is performed by performing drying by a hot air dryer generally at 90° C. to 200° C. for 0.3 to 10 minutes. The drying is preferably performed at 130° C. to 200° C. for 0.5 to 5 minutes.

The thickness of the back surface side antistatic layer is generally preferably in the range of 0.01 to 2 μm and more preferably in the range of 0.1 to 1 μm.

In order to improve the adhesiveness between the support and the back surface side antistatic layer, a surface treatment such as a corona discharge treatment, a plasma treatment, a flame treatment, and an ultraviolet irradiation treatment is performed on the back surface (the second surface) of the support on which the back surface side antistatic layer is formed.

### <Back Surface Side Flattening Layer>

The back surface side flattening layer is provided used for flattening together with preventing the falling off particles and the like included in the back surface side antistatic layer.

The back surface side flattening layer preferably includes a resin, a surfactant, and the like.

Examples of the resin that can be included in the back surface side flattening layer include a polyolefin such as low density polyethylene, low molecular weight polyethylene, and polypropylene; a (meth)acrylic acid/olefin copolymer (for example, a methacrylic acid/ethylene copolymer); a vinyl acetate/olefin copolymer (for example, a vinyl acetate/ethylene copolymer); an ionomer (for example, a methacrylic acid metal salt/ethylene copolymer (as metal, Zn, Na, K, Li, Ca, and Mg; Na, and Zn are preferable)); a fluororesin (for example, polytetrafluoroethylene, polychlorotrifluoroethylene, and polyvinylidene fluoride); and a fluorine-based acrylic resin (for example, a polymer of a fluoroalcohol ester of methacrylic acid). A copolymer (a (meth)acrylic acid/olefin copolymer, a vinyl acetate/olefin copolymer, and an ionomer) containing polyolefin and olefin units is preferable, and an ionomer is particularly preferable.

These resins are preferably used as the aqueous dispersion, in view of productivity. In a case where these resins are used as the aqueous dispersion, it is preferable to use an aqueous dispersion product of the resin having excellent film forming properties such that it is possible to form a film at a heating temperature of 150° C. or less.

The back surface side flattening layer can be formed by applying and drying the coating solution including these resins and the like.

The back surface side flattening layer preferably contains a matte agent. The addition of the matte agent can increase the slip properties, and thus gives a satisfactory effect to wear resistance and scratch resistance.

Examples of the material used in the matte agent include a fluorine-based resin and a low molecular weight polyolefin resin (for example, a polyethylene matting agent, a paraffin-based or microcrystalline-based wax emulsion), examples of the material used for the substantially spherical matting agent include beaded plastic powder (example material, crosslinked PMMA, polycarbonate, polyethylene terephthalate, polyethylene, or polystyrene), and inorganic particles (for example, SiO₂, Al₂O₃, talc, or kaolin).

The content of the matte agent is preferably 0.1 to 10 mass % with respect to the resin.

The back surface side flattening layer may contain a surfactant that is contained in the coating solution for forming the back surface side flattening layer used for increasing wettability to the support and improving levelability of the coating solution.

The surfactant may be any one of a cationic surfactant, an anionic surfactant, or a nonionic surfactant, examples of the fluorine-based surfactant include SURFLON (registered trademark) S231W (AGC Seimi Chemical Co., Ltd.), sodium=1.2-{bis(3,3,4,4,5,5,6,6,6-nanofluorohexylcarbonyl)} ethanesulfonate, examples of the anionic surfactant include sulfosuccinates or alkylsulfonates, and examples of the nonionic surfactant include polyoxyethylene alkyl ether.

The back surface side flattening layer may further include well-known materials such as a colorant, an ultraviolet absorbing agent, a crosslinking agent, an antioxidant, and a hydrophilizing agent, in a range of not remarkably deteriorating the properties of the image receiving sheet of the present embodiment, if desired.

The back surface side flattening layer can be formed by coating the back surface side antistatic layer with a coating solution (that is, a solution for forming a back surface side flattening layer) obtained by dispersing or dissolving a resin, a matte agent, and a surfactant in water or an organic solvent and performing heating and drying.

The coating may be performed by a well-known coating method such as an air doctor coater, a blade coater, a rod coater, a knife coater, a squeeze coater, a reverse roll coater, and a bar coater.

In a case where the aqueous dispersion is used as the resin, heating is required to the film formation temperature (generally about 80° C. to 150° C.) of the resin in a case of drying. The heating time is generally 10 seconds to 5 minutes.

The thickness of the back surface side flattening layer is preferably in the range of 0.01 to 1 μm and particularly preferably in the range of 0.02 to 0.5 μm.

The surface resistivity on the back surface side of the image receiving sheet of the present embodiment is preferably in the range of 10⁷ to 10¹⁰ Ω/sq. The surface resistivity of the back surface side of the image receiving sheet can be adjusted mainly by the content of the conductive material in the back surface side antistatic layer.

The image receiving sheet of the present embodiment can be suitably used for ink jet printing, in addition to for electrophotography.

The ink used for ink jet printing is not particularly limited, as long as the ink can be applied to printing in an ink jet method. Aqueous ink, solvent-based ink, and the like can be used.

The image receiving sheet of the present embodiment can be suitably used as the ink jet printing image receiving sheet applied in the printing using aqueous ink since, particularly even in a case where high speed printing is performed by using aqueous ink, fixing properties of the image is excellent, and bonding due to static electricity between stacked sheets is suppressed.

Hereinafter, aqueous ink that is suitably used in an ink jet printing image receiving sheet, an image forming method using aqueous ink, and an ink jet recording device are specifically described. However, the ink applied to the ink jet printing image receiving sheet which is one of the present embodiment, an image forming method, and an ink jet recording device are not limited thereto.

### [Aqueous Ink]

The aqueous ink includes a colorant, resin particles, water, and a water soluble high-boiling point organic solvent.

The aqueous ink may include other components in addition to the above, if necessary. Examples thereof include a surfactant, colloidal silica, urea, a water soluble macromolecular compound, a defoamer, and wax particles.

### (Colorant)

The aqueous ink includes at least one colorant.

The colorant included in the aqueous ink is not particularly limited, and can be suitably selected from a pigment, a dye, and the like. As the colorant, a pigment is preferable, and a resin-coated pigment having a structure in which at least a portion of the surface of the pigment is coated with a resin (hereinafter, also called a “coated resin”) is more preferable. Accordingly, the dispersion stability of the aqueous ink is improved, and a quality of the formed image is improved.

### Pigment

The pigment is not particularly limited and can be appropriately selected. For example, the pigment may be any one of an organic pigment or an inorganic pigment. As the coloration pigment, a carbon black pigment, a magenta pigment, a cyan pigment, and a yellow pigment may be used. The pigment is preferably almost insoluble or sparingly soluble in water, in view of coloration properties of the aqueous ink.

Examples of the organic pigment include an azo pigment, a polycyclic pigment, a chelate dye, a nitro pigment, a nitroso pigment, and aniline black. Among these, an azo pigment and a polycyclic pigment are preferable.

Examples of the inorganic pigment include titanium oxide, iron oxide, calcium carbonate, barium sulfate, aluminum hydroxide, barium yellow, cadmium red, chrome yellow, and carbon black.

An average primary particle diameter of the pigment is small in view of color reproducibility. However, in view of the light fastness, the average primary particle diameter is preferably great. In view of compatibility of the both, an average primary particle diameter is preferably 10 nm to 200 nm, more preferably 10 nm to 150 nm, and even more preferably 10 nm to 120 nm. The particle size distribution of the pigment is not particularly limited, and may be any one of a broad particle size distribution or a monodisperse particle size distribution. Two or more kinds of pigments having monodisperse particle size distribution may be mixed to be used.

The average primary particle diameter and the particle size distribution employs a value measured by a particle size distribution determination device using light scattering (for example, MICROTRAC UPA (registered trademark) EX 150 manufactured by Nikkiso Co., Ltd.).

The pigments may be used singly or two or more kinds thereof may be used in combination.

In view of image density, the content of the pigment in the aqueous ink is preferably 1 mass % to 20 mass % and more preferably 2 mass % to 10 mass % with respect to the total amount of the aqueous ink.

### Coated Resin

As the coated resin in the resin-coated pigment, a dispersing agent is preferable, and a polymer dispersing agent is more preferable. The polymer dispersing agent may be any one of a water soluble dispersing agent or a water insoluble dispersing agent.

Among the polymer dispersing agent, examples of the water soluble dispersing agent include a Hydrophilic macromolecular compound. Examples of a natural hydrophilic macromolecular compound include a vegetable polymer such as arabic gum, tragacanth gum, guar gum, karaya gum, locust bean gum, arabinogalactan, pectin, and quince seed starch, a seaweed-based polymer such as alginic acid, carrageenan, and agar, an animal-based polymer such as gelatin, casein, albumin, and collagen, and a microbial polymer such as xanthan gum and dextran.

Examples of the hydrophilic macromolecular compound obtained by modifying a raw material with a natural product include a fibrous polymer such as methyl cellulose, ethyl cellulose, hydroxyethyl cellulose, hydroxypropyl cellulose, and carboxymethyl cellulose, a starch type polymer such as sodium starch glycolate and starch phosphate ester sodium, and a seaweed polymer such as sodium alginate and propylene glycol alginate ester.

Examples of the synthetic hydrophilic polymer compound include a vinyl-based polymer such as polyvinyl alcohol, polyvinyl pyrrolidone, and polyvinyl methyl ether, an acrylic resin such as a non-crosslinked polyacrylamide, a polyacrylic acid or an alkali metal salt thereof, and a water soluble styrene acrylic resin, a water soluble styrene maleic acid resin, a water soluble vinyl naphthalene acrylic resin, a water soluble vinyl naphthalene maleic acid resin, an alkali metal salt of a β-naphthalenesulfonic acid formalin condensate, a macromolecular compound having in a side chain a salt of a cationic functional group such as a quaternary ammonium or an amino group, and a natural macromolecular compound such as shellac.

Among these, a water soluble dispersing agent into which a carboxy group is introduced such as a homopolymer of acrylic acid, methacrylic acid, and styrene acrylic acid, and a copolymer with a monomer having other hydrophilic groups is preferable.

Among the polymer dispersing agents, as the water insoluble dispersing agent, a polymer having both a hydrophobic portion and a hydrophilic portion can be used. The hydrophilic portion is preferably a structural unit having an acidic group, and more preferably a structural unit having a carboxy group. Examples of the water insoluble dispersing agent include a styrene-(meth)acrylic acid copolymer, a styrene-(meth)acrylic acid-(meth)acrylic acid ester copolymer, a (meth)acrylic acid ester-(meth)acrylic acid copolymer, a polyethylene glycol (meth)acrylate-(meth)acrylic acid copolymer, a vinyl acetate-maleic acid copolymer, and a styrene-maleic acid copolymer.

Specific examples thereof include water insoluble resins disclosed in JP2005-41994A, JP2006-273891A, JP2009-084494A, and JP2009-191134A.

The weight-average molecular weight of the polymer dispersing agent is preferably 3,000 to 100,000, more preferably 5,000 to 50,000, even more preferably 5,000 to 40,000, and particularly preferably 10,000 to 40,000.

The weight-average molecular weight is measured by gel permeation chromatography (GPC).

GPC can be performed by using HLC-8020GPC (manufactured by Tosoh Corporation), using three items of TSKgel (registered trademark), Super Multipore HZ-H (manufactured by Tosoh Corporation, 4.6 mmID×15 cm) as a column, and using tetrahydrohuran (THF) as an eluant.

GPC can be performed by setting a sample concentration as 0.45 mass %, a flow rate as 0.35 ml/min, a sample injection volume as 10 μl, and a measurement temperature as 40° C. and by using a differential refractive index (RI) detector.

The calibration curve can be prepared from eight samples of “Standard sample TSK standard, polystyrene” of Tosoh Corporation:“F-40”, “F-20”, “F-4”, “F-1”, “A-5000”, “A-2500”, “A-1000”, and “n-propylbenzene”.

In view of self dispersibility, the polymer dispersing agent preferably has a carboxy group, preferably has a carboxy group and an acid value of 130 mgKOH/g or less, and more preferably has an acid value of 25 mgKOH/g to 120 mgKOH/g. Particularly, the polymer dispersing agent having a carboxy group and having an acid value of 25 mgKOH/g to 100 mgKOH/g is effective.

The mixing mass ratio (p:s) of the pigment (p) and the dispersing agent (s) is preferably in the range of 1:0.06 to 1:3, more preferably in the range of 1:0.125 to 1:2, and even more preferably in the range of 1:0.125 to 1:1.5.

The content of the coated resin obtained by coating a pigment is preferably 0.5 mass % to 3.0 mass %, more preferably 1.0 mass % to 2.8 mass %, and even more preferably 1.2 mass % to 2.5 mass % with respect to the total mass of the aqueous ink.

The volume average particle diameter (secondary particle diameter) of the resin-coated pigment (pigment in the dispersed state) is preferably 10 nm to 200 nm, more preferably 10 nm to 150 nm, and even more preferably 10 nm to 100 nm. In a case where the volume average particle diameter is 200 nm or less, the color reproducibility becomes satisfactory, and thus the jetting properties in a case of ejection by an ink jet method become satisfactory. In a case where the volume average particle diameter is 10 nm or greater, the light fastness becomes satisfactory.

The volume average particle diameter (secondary particle diameter) employs a value measured by a particle size distribution determination device using light scattering (for example, MICROTRAC UPA (registered trademark) EX 150 manufactured by Nikkiso Co., Ltd.).

The particle size distribution of the resin-coated pigment is not particularly limited, and may be any one of a broad particle size distribution or a monodisperse particle size distribution. Two or more kinds of colorants having monodisperse particle size distribution may be mixed to be used. The volume average particle diameter of the pigment in the dispersed state indicates the average particle diameter in the state of ink formation, but the same applies to the so-called concentrated ink dispersion in a previous step of the ink formation.

The resin obtained by coating the pigment in the resin-coated pigment is preferably crosslinked with the crosslinking agent.

That is, the resin-coated pigment is preferably a resin-coated pigment in which at least a portion of the surface of the pigment is coated with the resin crosslinked with the crosslinking agent.

With respect to the resin-coated pigment in which at least a portion of the surface of the pigment is coated with the resin crosslinked with the crosslinking agent, paragraphs 0029 to 0048, 0110 to 0118, and 0121 to 0129 of JP2012-162655A, and paragraphs 0035 to 0071 of JP2013-47311A can be suitably referred to.

Examples of the dispersion of the pigment in the aqueous ink include a method of using the low-molecular-weight surfactant-type dispersing agent, in addition to the method using the polymer dispersing agent. Examples of the low-molecular-weight surfactant-type dispersing agent include a well-known low-molecular-weight surfactant-type dispersing agent disclosed in paragraphs 0047 to 0052 of JP2011-178029A.

The crosslinking agent is not particularly limited, as long as the crosslinking agent is a compound having two or more portions that react with the resin. However, among these, in view of excellent reactivity with a carboxy group, the crosslinking agent is preferably a compound having two or more epoxy groups (a bifunctional or higher functional epoxy compound).

Specific examples of the crosslinking agent include ethylene glycol diglycidyl ether, polyethylene glycol diglycidyl ether, 1,6-hexanediol diglycidyl ether, diethylene glycol diglycidyl ether, dipropylene glycol diglycidyl ether, polypropylene glycol diglycidyl ether, and trimethylolpropane triglycidyl ether. Polyethylene glycol diglycidyl ether, diethylene glycol diglycidyl ether, and trimethylolpropane triglycidyl ether are preferable.

As the crosslinking agent, a commercially available product may be used. Examples of the commercially available product include Denacol (registered trademark) EX-321, EX-821, EX-830, EX-850, and EX-851 (manufactured by Nagase ChemteX Corporation).

In view of a crosslinking reaction rate and stability of dispersion liquid of the resin coating content after the crosslinking, the molar ratio of a crosslinking portion (for example, an epoxy group) of the crosslinking agent and the crosslinked portion (for example, a carboxy group) of the resin is preferably 1:1 to 1:10, more preferably 1:1 to 1:5, and most preferably 1:1 to 1:1.5.

### (Resin Particles)

The aqueous ink contains at least one kind of resin particles. Accordingly, the image can be easily fixed on the image receiving sheet.

As the resin particles, for example, particles of the resin selected from a thermoplastic resin and a thermosetting resin can be used.

These resins may be a modified resin.

Examples of the resin include an acrylic resin, an epoxy resin, a urethane resin, polyether, polyamide, unsaturated polyester, polyolefin, a phenol resin, a silicone resin, a fluorine resin, polyvinyl (for example, vinyl chloride, vinyl acetate, polyvinyl alcohol, and polyvinyl butyral), an alkyd resin, polyester (for example, phthalic acid resin), an amino resin (for example, a melamine resin, a melamine formaldehyde resin, an amino alkyd co-condensation resin, and a urea resin).

The resin may be a copolymer including two or more kinds of structural units forming the above exemplified resin or may be a mixture of two or more kinds of resins. In addition to resin particles consisting of a mixture of two or more kinds of resins, the resin may be composite resin particles obtained by laminating two or more kinds of resins such as core/shell, for example.

The resin particles may be used singly or two or more kinds thereof may be used in combination.

As the resin particles, particles of an acrylic resin, a urethane resin, polyether, polyester, and polyolefin are preferable. In view of stability and the film quality of the formed film (image), particles of an acrylic resin or particles of a urethane resin are even more preferable.

For example, the aqueous ink may include, for example, resin particles in the form of an aqueous dispersion including resin particles, so-called latex.

The glass transition temperature (Tg) of the resin is preferably 30° C. or higher.

The upper limit of the glass transition temperature of the resin is preferably 250° C.

The glass transition temperature of the resin is preferably in the range of 50° C. to 230° C.

The glass transition temperature of the resin particles can be suitably controlled according to the generally used method. For example, the glass transition temperature of the resin particles can be controlled to a desired range by suitably selecting a kind and a composition ratio of a monomer (polymerizable compound) forming the resin particles, a molecular weight of the polymer for forming the resin particles, and the like.

The resin particles are preferably resin particles obtained by a phase-transfer emulsification method, and particles (self dispersibility polymer particles) of the following self dispersibility polymer are more preferable.

Here, the self dispersibility polymer refers to a water-insoluble polymer that can become a dispersed state in an aqueous medium by a functional group (particularly, an acidic group, a carboxy group, or the like or a salt thereof) included in the polymer in a case of a dispersed state by the phase-transfer emulsification method in the absence of the surfactant.

Here, the dispersed state includes both states: an emulsified state in which the water-insoluble polymer is dispersed in the aqueous medium in a liquid state (emulsion), and a dispersed state (suspension) in which the water-insoluble polymer is dispersed in the aqueous medium in a solid state.

The expression “water insoluble” indicates that the dissolution amount is less than 5.0 parts by mass with respect to 100 parts by mass of water (25° C.).

Examples of the phase-transfer emulsification method include a method of dissolving or dispersing a polymer in a solvent (for example, a water soluble solvent), introducing the resultant without adding a surfactant, and performing stirring and mixing in a state of neutralizing a salt-forming group (for example, an acidic group) included in the polymer, and removing the solvent, to obtain an aqueous dispersion which is in an emulsification or dispersed state.

The self dispersibility polymer particles can be selected from the self dispersibility polymer particles disclosed in paragraphs 0090 to 0121 of JP2010-64480A and paragraphs 0130 to 0167 of JP2011-068085A. Particularly, among the self dispersibility polymer particles disclosed in the documents, self dispersibility polymer particles having the glass transition temperature of 100° C. or greater are preferably selected to be used.

As described above, as the self dispersibility polymer particles, self dispersibility polymer particles having the carboxy group are preferable.

The more preferable form of the self dispersibility polymer particles having the carboxy group is a form of particles formed with the polymer including a structural unit derived from unsaturated carboxylic acid (preferably (meth)acrylic acid).

The even more preferable form of the self dispersibility polymer particles having the carboxy group is a form of particles formed with a polymer including a structural unit having an alicyclic group, a structural unit having an alkyl group, and a structural unit derived from unsaturated carboxylic acid (preferably (meth)acrylic acid).

In the polymer, the content (total content in a case where two or more kinds thereof exist) of the structural unit having an alicyclic group is preferably 3 mass % to 95 mass %, more preferably 5 mass % to 75 mass %, and even more preferably 10 mass % to 50 mass % with respect to the total amount of the polymer.

In the polymer, content (total content in a case where two or more kinds thereof exist) of the structural unit having an alkyl group is preferably 5 mass % to 90 mass %, more preferably 10 mass % to 85 mass %, even more preferably 20 mass % to 80 mass %, even more preferably 30 mass % to 75 mass %, and even more preferably 40 mass % to 75 mass % with respect to the total amount of the polymer.

The content (total content in a case where two or more kinds thereof exist) of the structural unit derived from unsaturated carboxylic acid (preferably (meth)acrylic acid) in the polymer is preferably 2 mass % to 30 mass %, more preferably 5 mass % to 20 mass %, and even more preferably 5 mass % to 15 mass % with respect to the total amount of the polymer.

As the form of the self dispersibility polymer particles having a carboxy group, with respect to the above “even more preferable form of the self dispersibility polymer particles having a carboxy group”, a form obtained by changing the structural unit having an alicyclic group to a structural unit having an aromatic group or a form of including a structural unit having an aromatic group in addition to a structural unit having an alicyclic group are also preferable.

In all of the forms, the total content of the structural unit having an alicyclic group and the structural unit having an aromatic group is preferably 3 mass % to 95 mass %, more preferably 5 mass % to 75 mass %, and even more preferably 10 mass % to 50 mass % with respect to the total amount of the polymer.

The structural unit having an alicyclic group is preferably a structural unit derived from alicyclic (m eth)acryl ate.

Examples of the alicyclic (meth)acrylate include monocyclic (meth)acrylate, bicyclic (meth)acrylate, and tricyclic (meth)acrylate.

Examples of the monocyclic (meth)acrylate include cycloalkyl (meth)acrylate having 3 to 10 carbon atoms of a cycloalkyl group such as cyclopropyl (meth)acrylate, cyclobutyl (meth)acrylate, cyclopentyl (meth)acrylate, cyclohexyl (meth)acrylate, cycloheptyl (meth)acrylate, cyclooctyl (meth)acrylate, cyclononyl (meth)acrylate, and cyclodecyl (meth)acrylate.

Examples of the bicyclic (meth)acrylate include isobornyl (meth)acrylate and norbornyl (meth)acrylate.

Examples of the tricyclic (meth)acrylate include adamantyl (meth)acrylate, dicyclopentanyl (meth)acrylate, and dicyclopentenyloxyethyl (meth)acrylate.

The alicyclic (meth)acrylate may be used singly or two or more kinds thereof may be mixed to be used.

Among the alicyclic (meth)acrylate, in view of fixing properties, blocking resistance, and dispersion stability of self dispersibility polymer particles, bicyclic (meth)acrylate or tricyclic or greater polycyclic (meth)acrylate is preferable, and isobornyl (meth)acrylate, adamantyl (meth)acrylate, or dicyclopentanyl (meth)acrylate are more preferable.

The structural unit having an aromatic group is preferably a structural unit derived from an aromatic group containing monomer.

Examples of the aromatic group containing monomer include an aromatic group containing (meth)acrylate monomer (for example, phenoxyethyl (meth)acrylate, benzyl (meth)acrylate, and phenyl (meth)acrylate), and a styrene-based monomer.

Among these, in view of balance between the hydrophilicity and hydrophobicity of the polymer chain and ink fixing properties, an aromatic group containing (meth)acrylate monomer is preferable, phenoxyethyl (meth)acrylate, benzyl (meth)acrylate, or phenyl (meth)acrylate is more preferable, and phenoxyethyl (meth)acrylate or benzyl (meth)acrylate is even more preferable.

The structural unit having an alkyl group is preferably a structural unit derived from an alkyl group containing monomer.

Examples of the alkyl group containing monomer include alkyl (meth)acrylate such as methyl (meth)acrylate, ethyl (meth)acrylate, isopropyl (meth)acrylate, n-propyl (meth)acrylate, n-butyl (meth)acrylate, isobutyl (meth)acrylate, t-butyl (meth)acryl ate, hexyl (meth)acrylate, ethylhexyl (meth)acrylate; an ethylenically unsaturated monomer having a hydroxyl group such as hydroxymethyl (meth)acrylate, 2-hydroxyethyl (meth)acrylate, 2-hydroxypropyl (meth)acrylate, 4-hydroxybutyl (meth)acrylate, hydroxypentyl (meth)acrylate, and hydroxyhexyl (meth)acrylate; dialkylaminoalkyl (meth)acrylate such as dimethylaminoethyl (meth)acrylate; (meth)acrylamide such as N-hydroxyalkyl (meth)acrylamide such as N-hydroxymethyl (meth)acrylamide, N-hydroxyethyl (meth)acrylamide, and N-hydroxybutyl (meth)acrylamide; and N-alkoxyalkyl (meth)acrylamide such as N-methoxymethyl (meth)acrylamide, N-ethoxymethyl (meth)acrylamide, N-(n-, iso) butoxymethyl (meth)acrylamide, N-methoxyethyl (meth)acrylamide, N-ethoxyethyl (meth)acrylamide, and N-(n-, iso) butoxyethyl (meth)acrylamide.

Among these, alkyl (meth)acrylate is preferable, alkyl (meth)acrylate having 1 to 4 carbon atoms of an alkyl group is more preferable, methyl (meth)acrylate, ethyl (meth)acrylate, isopropyl (meth)acrylate, and butyl (meth)acrylate are even more preferable, and methyl (meth)acrylate is still even more preferable.

Hereinafter, specific examples of the self dispersibility polymer particles include Example Compounds P-1 to P-5, but the present invention is not limited thereto. Numbers in parentheses indicate mass ratios of a copolymerization component.
P-1: A methyl methacrylate/isobornyl methacrylate/methacrylic acid copolymer (70/20/10)
P-2: A methyl methacrylate/isobornyl methacrylate/methacrylic acid copolymer (48/42/10)
P-3: A methyl methacrylate/benzyl methacrylate/methacrylic acid copolymer (65/25/10)
P-4: An isopropyl methacrylate/isobornyl methacrylate/methacrylic acid copolymer (50/40/10)
P-5: A butyl methacrylate/dicyclopentanyl methacrylate/methacrylic acid copolymer (60/30/10)

The weight-average molecular weight of the polymer forming the resin particles (preferably self dispersibility polymer particles. the same is applied below) is preferably 3,000 to 200,000, more preferably 5,000 to 150,000, and even more preferably 10,000 to 100,000.

In a case where the weight-average molecular weight is 3,000 or greater, the amount of the water soluble component can be effectively suppressed. In a case where the weight-average molecular weight is 200,000, the self dispersion stability can be increased.

The weight-average molecular weight employs a value measured by the aforementioned gel permeation chromatography (GPC).

In view of self dispersibility, the polymer of forming the resin particles is preferably a polymer having an acid value of 100 mgKOH/g or less and is more preferably a polymer having an acid value of 25 mgKOH/g to 100 mgKOH/g.

The volume average particle diameter of the resin particles is preferably in the range of 1 nm to 200 nm, more preferably in the range of 1 nm to 150 nm, even more preferably in the range of 1 nm to 100 nm, and particularly preferably in the range of 1 nm to 10 nm. In a case where the volume average particle diameter is 1 nm or greater, manufacturing suitability is improved. In a case where the volume average particle diameter is 200 nm or less, the preservation stability is improved. The particle size distribution of the resin particles is not particularly limited, and may be any one of broad particle size distribution or monodisperse particle size distribution. Two or more kinds of the resin particles may be mixed to be used.

The volume average particle diameter employs a value measured by the aforementioned method.

The content (total content in a case where two or more kinds thereof exist) of the resin particles (preferably, self dispersibility polymer particles) in the aqueous ink is not particularly limited. However, the content is preferably 0.3 mass % to 15.0 mass %, more preferably 4.0 mass % to 12.0 mass %, and even more preferably 7.0 mass % to 9.0 mass % with respect to the total amount of the aqueous ink.

In a case where the content of the resin particles in the aqueous ink is 0.3 mass % or greater, the rub resistance of the image is improved, and image unevenness can be suppressed.

In a case where the content of the resin particles in the aqueous ink is 15.0 mass % or less, jettability of the ink can be improved.

### (Water)

The aqueous ink includes water. The content of water included in the aqueous ink is not particularly limited. However, the content of water is, for example, 50 mass % or greater with respect to the total amount of the aqueous ink.

The content of water included in the aqueous ink is preferably 50 mass % to 80 mass %, more preferably 50 mass % to 75 mass %, and even more preferably 50 mass % to 70 mass % with respect to the total amount of the aqueous ink.

### (Water Soluble High-Boiling Point Solvent)

The aqueous ink includes at least one water soluble high-boiling point solvent.

In a case where the aqueous ink includes the water soluble high-boiling point solvent, jettability from a head and preservation stability are secured.

The expression “water soluble” indicates that the dissolution amount is less than 5.0 parts by mass with respect to 100 parts by mass of water (25° C.).

The boiling point of the water soluble high-boiling point solvent is preferably 200° C. or greater, more preferably 200° C. to 400° C., and even more preferably 300° C. to 400° C.

In a case where the boiling point is 200° C. or greater, jettability and preservation stability of the aqueous ink are excellent. Meanwhile, in a case where the boiling point is 400° C. or less, viscosity of the aqueous ink does not become too high, and jettability becomes excellent.

The boiling point can be obtained by a boiling point measuring device (manufactured by Titan Technology Group LLC., boiling point measuring device DosaTherm 300).

As the water soluble high-boiling point solvent, a well-known water soluble high-boiling point solvent can be used without particular limitation.

Examples of the water soluble high-boiling point solvent include sugars and sugar alcohols, hyaluronic acids, alkyl alcohols having 1 to 4 carbon atoms, glycol ethers, 2-pyrrolidone, and N-methyl-2-pyrrolidone disclosed in paragraph 0116 of JP2011-42150A, in addition to polyhydric alcohols such as glycols such as glycerin, 1,2,6-hexanetriol, trimethylolpropane, ethylene glycol, propylene glycol, diethylene glycol, triethylene glycol, tetraethylene glycol, pentaethylene glycol, and dipropylene glycol, and alkanediol such as 2-butene-1,4-diol, 2-ethyl-1,3-hexanediol, 2-methyl-2,4-pentanediol, 1,2-octanediol, 1,2-hexanediol, 1,2-pentanediol, and 4-methyl-1,2-pentanediol.

These solvents may be used singly or two or more kinds thereof may be used in combination. Polyhydric alcohols are also useful as an anti-drying agent and a wetting agent, and examples thereof include examples disclosed, for example, in paragraph 0117 of JP2011-42150A. The polyol compound is preferable as a permeation agent, and examples of aliphatic diol include examples disclosed, for example, in paragraph 0117 of JP2011-42150A.

As the other water soluble high-boiling point solvent, for example, a water soluble high-boiling point solvent can be suitably selected from water soluble solvents disclosed in paragraphs 0176 to 0179 of JP2011-46872A, water soluble solvents disclosed in paragraphs 0063 to 0074 of JP2013-18846A.

The content (total content in a case where two or more kinds thereof exist) in the aqueous ink of the water soluble high-boiling point solvent is preferably 2 mass % to 20 mass % with respect to the total amount of the aqueous ink.

In a case where the total content is 2 mass % or greater, jettability from a head and preservation stability are improved.

The total content of the water soluble high-boiling point solvent is more preferably 3 mass % to 20 mass % and even more preferably 5 mass % to 18 mass % with respect to the total amount of the aqueous ink.

The aqueous ink more preferably contains Solvent A represented by Structural Formula (I) as the water soluble high-boiling point solvent and Solvent B which is at least one selected from ethylene glycol, diethylene glycol, triethylene glycol, tetraethylene glycol, and pentaethylene glycol.

According to the above composition, jettability and preservation stability are improved.

In a case where the aqueous ink includes Solvent A and Solvent B, the content of Solvent A with respect to the total amount of the aqueous ink is 1.0 mass % to 10.0 mass %, and the content (based on mass) of Solvent B with respect to the total amount of the aqueous ink is preferably 0.05 times to 20.0 times of the content (based on mass) with respect to the total amount of the aqueous ink of Solvent A.

In the present specification, the expression “the content (based on mass) of Solvent B with respect to the total amount of the aqueous ink is a times to b times (for example, 0.05 times to 20.0 times) of the content (based on mass) of Solvent A with respect to the total amount of the aqueous ink” may be indicated as a “ratio [mass of Solvent B/mass of Solvent A] is a to b (for example, 0.05 to 20.0)”.

The ratio [mass of Solvent B/mass of Solvent A] is preferably 0.1 to 15.0 and more preferably 0.2 to 10.0.

In a case where the aqueous ink includes Solvents A and B, the total content of Solvents A and B is preferably 2.0 mass % to 30.0 mass %, more preferably 3.0 mass % to 20.0 mass %, and even more preferably 5.0 mass % to 15.0 mass % with respect to the total amount of the aqueous ink.

In a case where the aqueous ink includes Solvents A and B, the content of Solvent B is preferably 0.5 mass % to 20.0 mass %, more preferably 1.0 mass % to 15.0 mass %, and even more preferably 2.0 mass % to 10.0 mass % with respect to the total amount of the aqueous ink.

### Solvent A

Solvent A is at least one selected from a compound represented by Structural Formula (I). Solvent A may be a solvent (of a single component) consisting of one selected from the compound represented by Structural Formula (I) and may be a mixed solvent consisting of two or more kinds selected from the compound represented by Structural Formula (I).

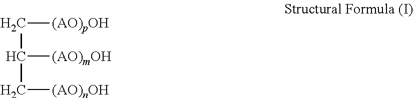

In Structural Formula (I), p, m, and n each independently represent an integer of 0 or greater, and p+m+n=0 to 15 is satisfied. Among these, p+m+n is preferably in the range of 3 to 12, and more preferably in the range of 3 to 10. In Structural Formula (I), AO represents an ethyleneoxy group or a propyleneoxy group. Among these, a propyleneoxy group is preferable. In a case where p+m+n≧2, AO of 2 or greater may be identical to or different from each other.

The compound represented by Structural Formula (I) is preferably glycerin, or an alkylene oxide adduct of glycerin.

Hereinafter, examples of the compound represented by Structural Formula (I) are provided. Here, the present invention is not limited thereto.

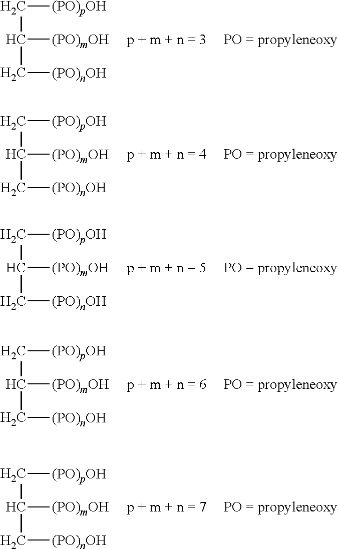

nC₄H₉O(AO)₄—H
(AO=EO or PO(EO:PO=1:1))
nC₄H₉O(AO)₁₀—H
(AO=EO or PO(EO:PO=1:1))
HO(A′O)₄₀—H
(A′O=EO or PO(EO:PO=1:3))
HO(A′″O)₅₅—H
(A″O=EO or PO(EO:PO=5:6))
HO(PO)₃—H
HO(PO)₇—H
1,2-Hexane diol

EO and PO represent an ethyleneoxy group and a propyleneoxy group, respectively.

As an alkylene oxide adduct of glycerin, a commercially available product may be used. Examples of polyoxypropylated glycerin (ether of polypropylene glycol and glycerin) include SANNIX (registered trademark) GP-250 (average molecular weight: 250), GP-400 (average molecular weight: 400), GP-600 (average molecular weight: 600) [hereinafter, manufactured by Sanyo Chemical Industry Ltd.], LEOCON (registered trademark) GP-250 (average molecular weight: 250), GP-300 (average molecular weight: 300), GP-400 (average molecular weight: 400), GP-700 (average molecular weight: 700) [above, manufactured by Lion Corporation], Polypropylene triol glycol•triol type (average molecular weight: 300, average molecular weight: 700) [above, manufactured by Wako Pure Chemical Industries, Ltd.].

### Solvent B

Solvent B is at least one selected from the group consisting of ethylene glycol, diethylene glycol, triethylene glycol, tetraethylene glycol (for example, PEG-200 described below), pentaethylene glycol, propylene glycol, and methyl propylene triglycol (MFTG). Solvent B preferably includes at least one selected from triethylene glycol and tetraethylene glycol.

Solvent B may be a solvent (of a single component) consisting of one kind thereof and may be a mixed solvent consisting of two or more kinds thereof.

As the Solvent B, a commercially available product may be used.

Examples thereof include PEG-200 (average molecular weight: 200), PEG-300 (average molecular weight: 300), PEG-400 (average molecular weight: 400) [above, manufactured by Sanyo Chemical Industry Ltd.], PEG#200 (average molecular weight: 200), PEG#300 (average molecular weight: 300), PEG#400 (average molecular weight: 400) [above, manufactured by Lion Corporation], PEG#200 (average molecular weight: 200), PEG#300 (average molecular weight: 300), PEG#400 (average molecular weight: 400) [above, manufactured by NOF Corporation], PEG200 (average molecular weight: 200), PEG300 (average molecular weight: 300), and PEG400 (average molecular weight: 400) [above, manufactured by DKS Co., Ltd.].

### (Surfactant)

The aqueous ink may contain at least one surfactant, if necessary. For example, the surfactant can be used as a surface tension adjuster.

As the surfactant, a compound having a structure having a hydrophilic portion and a hydrophobic portion in a molecule may be effectively used, and all of an anionic surfactant, a cationic surfactant, an amphoteric surfactant, a nonionic surfactant, and a betaine-based surfactant can be used. The aforementioned polymer dispersing agent may be used as a surfactant.

In view of suppressing of aqueous ink ejection interference, the surfactant is preferably a nonionic surfactant. Among these, an acetylene glycol derivative (an acetylene glycol-based surfactant) is more preferable.

Examples of the acetylene glycol-based surfactant include an alkylene oxide adduct of 2,4,7,9-tetramethyl-5-decyne-4,7-diol and 2,4,7,9-tetramethyl-5-decyne-4,7-diol, and at least one selected from these is preferable. Examples of the commercially available product of these compounds include an E series such as OLFINE E1010 manufactured by Nissin Chemical Co., Ltd.

As the surfactant other than the acetylene glycol-based surfactant, a fluorine-based surfactant is preferable. Examples of the fluorine-based surfactant include an anionic surfactant, a nonionic surfactant, and a betaine-based surfactant. Among these, an anionic surfactant is more preferable. Examples of the anionic surfactant include CAPSTONE FS-63 and CAPSTONE FS-61 (manufactured by Dupont), FTERGENT 100, FTERGENT 110, and FTERGENT 150 (manufactured by NEOS Company Limited), and CHEMGUARD S-760P (manufactured by Chemguard Inc.).

In a case where the surfactant (that is, a surface tension adjuster) is contained in the aqueous ink, in view of ejecting aqueous ink by an ink jet method in a satisfactory manner, the surfactant preferably contains aqueous ink in an amount in the range in which the surface tension of the aqueous ink can be adjusted to 20 mN/m to 60 mN/m. In view of surface tension, the surface tension is more preferably 20 mN/m to 45 mN/m, and even more preferably 25 mN/m to 40 mN/m.

Here, the surface tension of the aqueous ink indicates a value measured under the condition of a liquid temperature of 25° C. by using an Automatic Surface Tensiometer CBVP-Z (manufactured by Kyowa Interface Science Co., Ltd.).

In a case where the aqueous ink includes a surfactant, a specific amount of the surfactant is not particularly limited. However, the amount thereof is preferably 0.1 mass % or greater, more preferably 0.1 mass % to 10 mass %, and even more preferably 0.2 mass % to 3 mass % with respect to the total amount of the aqueous ink.

### (Colloidal Silica)

The aqueous ink may contain colloidal silica, if necessary.

Accordingly, stability in a case of continuous ejection of ink can be increased.

The colloidal silica is colloid consisting of particles inorganic oxide including silicon having an average particle diameter of several 100 nm or less. The colloidal silica includes silicon dioxide (including hydrate thereof) as a main component and may include aluminate (sodium aluminate, potassium aluminate, and the like) as a minor component.

The colloidal silica may include inorganic salts such as sodium hydroxide, potassium hydroxide, lithium hydroxide and ammonium hydroxide, and organic salts such as tetramethylammonium hydroxide. These inorganic salts and organic salts, for example, function as colloidal stabilizers.

With respect to the colloidal silica, for example, disclosure of paragraphs 0043 to 0050 of JP2011-202117A can be suitably referred to.

Instead of colloidal silica or in addition to colloidal silica, the aqueous ink may contain alkali metal silicate salt, if necessary. With respect to the alkali metal silicate salt, disclosure of paragraphs 0052 to 0056 of JP2011-202117A can be suitably referred to.

A commercially available product may be used, and examples of the commercially available product include SNOWTEX (registered trademark) XS manufactured by Nissan Chemical Industries, Ltd.

In a case where the aqueous ink includes colloidal silica, the content of the colloidal silica is preferably 0.0001 mass % to 10 mass %, more preferably 0.01 mass % to 3 mass %, even more preferably 0.02 mass % to 0.5 mass %, and particularly preferably 0.03 mass % to 0.3 mass % with respect to the total amount of the aqueous ink.

### (Urea)

The aqueous ink may contain urea.

Since urea has a high moisturizing function, it is possible to effectively suppress undesirable drying or solidification of the ink as a solid wetting agent.

Since the aqueous ink includes colloidal silica and urea described above, the maintainability (that is, the wiping workability) of the ink jet head or the like is effectively improved.

In view of improvement of maintenance properties (wiping workability), the content of the urea in the aqueous ink is preferably 1 mass % to 20 mass %, more preferably 1 mass % to 15 mass %, and even more preferably 3 mass % to 10 mass %.

In a case where the aqueous ink contains urea and colloidal silica, a ratio of the content of urea and the content of colloidal silica is not particularly limited. However, a content ratio (urea/colloidal silica) of urea with respect to colloidal silica is preferably 5 to 1,000, more preferably 10 to 500, and even more preferably 20 to 200.

In a case where the aqueous ink contains urea and colloidal silica, the combination of the content of urea and the content of colloidal silica is not particularly limited. However, in view of improvement of wiping properties, the following combination is preferable.

That is, a combination in which the content of urea is 1.0 mass % or greater, and the content of colloidal silica is 0.01 mass % or greater is preferable, a combination in which the content of urea is 1.0 mass % to 20 mass % and the content of colloidal silica is 0.02 mass % to 0.5 mass % is more preferable, and a combination in which the content of urea is 3.0 mass % to 10 mass % and the content of colloidal silica is 0.03 mass % to 0.3 mass % is particularly preferable.

### (Water Soluble Macromolecular Compound)

The aqueous ink may contain at least one water soluble macromolecular compound, if necessary.

The water soluble macromolecular compound is not particularly limited, and a well-known water soluble macromolecular compound such as polyvinyl alcohol, polyacrylamide, polyvinyl pyrrolidone, and polyethylene glycol can be used.

Examples of the water soluble macromolecular compound include a water soluble macromolecular compound disclosed in paragraphs 0026 to 0080 of JP2013-001854A.

The commercially available product may be used, and examples of the commercially available product include PVP K-15 manufactured by ISB Corporation.

In a case where the aqueous ink contains a water soluble macromolecular compound, the content of the water soluble macromolecular compound is preferably 0.0001 mass % to 10 mass %, more preferably 0.01 mass % to 3 mass %, even more preferably 0.02 mass % to 0.5 mass %, and particularly preferably 0.03 mass % to 0.3 mass % with respect to the total amount of the aqueous ink.

### (Anti-Foaming Agent)

The aqueous ink may contain at least one anti-foaming agent, if necessary.

Examples of the anti-foaming agent include a silicone-based compound (that is, a silicone-based anti-foaming agent), and a pluronic compound (pluronic anti-foaming agent). Among these, a silicone-based anti-foaming agent is preferable.

The silicone-based anti-foaming agent is preferably a silicone-based anti-foaming agent having a polysiloxane structure.

As the anti-foaming agent, a commercially available product can be used.

Examples of the commercially available product include BYK (registered trademark)-012, 017, 021, 022, 024, 025, 038, and 094 (above, manufactured by BYK Japan K.K.), KS-537, KS-604, and KM-72F (above, manufactured by Shin-Etsu Chemical Co., Ltd.), TSA-739 (manufactured by Momentive Performance Materials Inc.), and OLFINE (registered trademark) AF104 (manufactured by Nissin Chemical Co., Ltd.).

Among these, BYK-017, 021, 022, 024, 025, 094, KS-537, KS-604, KM-72F, TSA-739 which are silicone-based anti-foaming agents are preferable. In view of jetting stability of ink, BYK-024 is most preferable.

In a case where the aqueous ink contains an anti-foaming agent, the content of the anti-foaming agent is preferably 0.0001 mass % to 1 mass % and more preferably 0.001 mass % to 0.1 mass % with respect to the total amount of the aqueous ink.

### (Wax Particles)

The aqueous ink can contain at least one kind of wax particles. Accordingly, rub resistance can be improved.

Examples of the wax particles include plant wax such as carnauba wax, candelilla wax, beeswax, rice wax, and lanolin, petroleum wax such as animal wax, paraffin wax, microcrystalline wax, polyethylene wax, oxidized polyethylene wax, and petrolatum, mineral wax such as montan wax and ozokerite, synthetic wax such as carbon wax, hoechst wax, polyolefin wax, and stearic acid amide, natural wax such as α-olefin.maleic anhydride copolymer, synthetic wax particles, and mixed particles thereof.

The wax particles are preferably added in the form of dispersion, and may be contained in the aqueous ink, for example, as a dispersion such as an emulsion. As the solvent in a case of the dispersion, water is preferable, but the present invention is not limited thereto. For example, a generally used organic solvent is suitably selected to be used in a case of dispersion. With respect to the organic solvent, disclosure of paragraph 0027 of JP2006-91780A can be referred to.

The wax particles may be used singly or a plurality of kinds thereof may be mixed to be used.

As the wax particles, a commercially available product may be used. Examples of the commercially available product include NOPCOTE PEM17 (manufactured by San Nopco Limited), CHEMIPERAL (registered trademark) W4005 (manufactured by Mitsui Chemicals, Inc.), AQUACER515 and AQUACER593 (all are manufactured by BYK Japan K.K.), and CELLOSOL 524 manufactured by Chukyo Yushi Co., Ltd.

Among the above, as the preferable wax, carnauba wax or polyolefin wax is preferable. In view of rub resistance, carnauba wax is particularly preferable.

In a case where the aqueous ink contains wax particles, the content ratio of the resin particles and the wax particles is preferably in the range (solid content ratio) of resin particles:wax particles=1:5 to 5:1. In a case where the content ratio of the resin particles and the wax particles is in the above range, it is possible to form an image having excellent rub resistance.

### (Other Components)

The aqueous ink may contain other components in addition to the above, if necessary.

Examples of the other component include well-known additives such as a solid wetting agent, an antifading agent, an emulsion stabilizer, a penetration enhancer, an ultraviolet absorbing agent, a preservative, an antibacterial agent, a pH adjuster, a viscosity adjuster, a rust inhibitor, and a chelating agent.

The aqueous ink may be an active energy ray (for example, ultraviolet ray) curable aqueous ink containing at least one polymerizable compound.

In this case, the aqueous ink preferably further includes a polymerization initiator.

Examples of the polymerizable compound include polymerizable compounds (for example, bifunctional or higher functional (meth)acrylamide compound) disclosed in paragraphs 0128 to 0144 of JP2011-184628A, paragraphs 0019 to 0034 of JP2011-178896A, or paragraphs 0065 to 0086 of JP2015-25076A.

Examples of the polymerization initiator include well-known polymerization initiators disclosed in paragraphs 0186 to 0190 of JP2011-184628A, paragraphs 0126 to 0130 of JP2011-178896A, or paragraphs 0041 to 0064 of JP2015-25076A.

### [Image Forming Method]

Subsequently, an image forming method suitable for forming an image by an ink jet method by using the image receiving sheet and the aqueous ink of the present embodiment is specifically described. The image forming method (hereinafter, referred to as the “image forming method” according to the present embodiment) for forming an image by using the aqueous ink on the image receiving sheet of the present embodiment includes an application step of applying an aqueous ink to the image receiving sheet by an ink jet method and a drying step of drying the applied aqueous ink, and may include other steps such as an irradiation step of performing irradiation with an active energy ray such as an ultraviolet ray, if necessary.

### <Application Step>

In the application step in the image forming method according to the present embodiment, an aqueous ink is applied by an ink jet method on the image receiving sheet of the present embodiment.

### ˜Ink Jet Method˜

The ink jet method is not particularly limited, and may be a well-known method, for example, any one of an electric charge control method in which ink is ejected by using electrostatic attraction force, a drop-on-demand method (pressure pulse method) in which vibration pressure of a piezo element is used, an acoustic ink jet method in which an electric signal is converted into an acoustic beam, ink is irradiated, and ink is ejected by using radiation pressure, and a thermal ink jet (BUBBLE JET (registered trademark)) of forming bubbles by heating ink and using the generated pressure. Particularly, as the ink jet method, an ink jet method in which ink subjected to the action of the thermal energy causes a sudden change in volume, and the ink is ejected from a nozzle by the action force due to this state change in a method disclosed in JP1979-59936A (JP-S54-59936A) can be effectively used.

As the ink jet head, there are a shuttle system in which a short serial head is used, and the head performs scanning in the width direction of the image receiving sheet to perform recording and a single pass method (line method) in which a line head in which recording elements are arranged corresponding to the entire area of one side of the image receiving sheet is used. In the single pass method, image recording can be performed on the entire surface of the image receiving sheet by scanning the image receiving sheet in a direction intersecting with the arrangement direction of the recording elements, and thus a transport system such as a carriage for scanning the short head becomes unnecessary. Complex scanning control between the movement of the carriage and the image receiving sheet becomes unnecessary and only the image receiving sheet moves, such that increase of the recording speed can be realized, compared with the shuttle system. The method of forming an image by the inkjet method in the manufacturing method of the present invention can be applied to any of these methods. However, generally, in a case where a single pass method in which dummy jetting is not performed is applied, improvement effects of the ejection accuracy and the abrasion resistance of the image are great, drawing can be performed at a high speed, and thus the single pass method is preferable.

In view of obtaining a high-definition image, the amount of ink droplets ejected from the ink jet head is preferably 1 pl to 10 pl (pico liter), more preferably 1.5 pl to 6 pl, and even more preferably 1.5 pl to 3 pl.

In view of improving the connection of continuous tone, it is effective to perform ejection by combining different liquid droplet amounts. Even in this case, the present invention can be suitably used.

In view of forming an image having a high resolution, it is preferable to deposit the aqueous ink at a resolution of 1,200 dpi×1,200 dpi (dot per inch) or greater.

In particular, in view of obtaining productivity of a printed product and a high definition image, it is preferable that the inkjet method is a single pass method and the aqueous ink is ejected under an ejection condition of a resolution of 1,200 dpi×1,200 dpi or greater.

In view of obtaining a high definition image, it is preferable to eject the aqueous ink under the ejection condition of the minimum liquid droplet size of 3 pl or less.

As an ink jet recording device that can eject aqueous ink under the ejection conditions as described above, Jet Press (registered trademark) 720 manufactured by Fujifilm Corporation can be suitably used.

### <Drying Step>

The image forming method of the present embodiment has a drying step of forming an image by drying aqueous ink under the condition in which the surface temperature of the image receiving layer of the image receiving sheet of the present embodiment is 30° C. or greater.

An object of the drying step is to remove at least a portion (preferably, all) of water in the aqueous ink, and the water soluble high-boiling point solvent in the aqueous ink may remain in the image receiving layer after the drying step.

In a case where the aqueous ink is dried in the condition in which the surface temperature of the image receiving layer in the drying step is 30° C. or greater is dried, water does not remain in the aqueous ink after drying, and fixing properties of the image are excellent.

The surface temperature can be measured by a handy radiation thermometer IT-540N manufactured by Horiba Ltd.

### ˜Drying Method˜

In the drying step, it is preferable that the aqueous ink is heated and dried.

Examples of means for performing heating and drying include well-known heating means such as a heater, well-known air blowing means such as a dryer, and means obtained by combining these.

Examples of the method for heating and drying include a method of applying warm air or hot air to a surface of the image receiving sheet on which the image receiving layer is formed, a method of applying heat to the surface of the image receiving sheet on which the image receiving layer is formed with an infrared heater, and a method obtained by combining a plurality of these.

The heating temperature of the image in a case of heating and drying is a temperature in which the surface temperature of the image receiving layer becomes 30° C. or greater, more preferably a temperature in which the surface temperature becomes 30° C. to 100° C., and even more preferably a temperature in which the surface temperature becomes 60° C. to 80° C.

The time for heating and drying of the image is not particularly limited. However, the time is preferably 1 second to 60 seconds, more preferably 1 second to 30 seconds, and particularly preferably 1 second to 20 seconds.

### [Ink Jet Recording Device]

An example of the ink jet recording device that can be used in printing is described.

### (Entire Configuration of Ink Jet Recording Device)

First, the entire configuration of the ink jet recording device is described.

The ink jet recording device is an ink jet recording device that records an image by ejecting ink of four colors of cyan (C), magenta (M), yellow (Y), and black (K) to a recording medium.

As the recording medium, the aforementioned image receiving sheet is used. The aforementioned aqueous ink is used as the ink.

The ink jet recording device mainly includes a supply unit that supplies an image receiving sheet, an image recording unit that ejects aqueous ink in an ink jet method to the image receiving layer of the image receiving sheet supplied from the supply unit and draws an image, an ink drying treatment unit that performs a drying treatment of the image receiving sheet on which the image is recorded, and a discharging unit that discharges and collects the image receiving sheet.

### Supply Unit

The supply unit supplies image receiving sheets stacked on a supply table to the image recording unit one by one. The supply unit mainly includes a supply table, a sucker device, a supply roller pair, a feeder board, and a supply drum.

### Image Recording Unit

The image recording unit ejects aqueous ink (For example, cyan ink (C), magenta ink (M), yellow ink (Y), and black ink (K)) to the surface of the image receiving sheet and draws an image to the image receiving layer of the image receiving sheet. This image recording unit mainly include an image recording drum that transports an image receiving sheet, a base material pressing roller that presses a image receiving sheet transported by the image recording drum and causes the image receiving sheet to be closely attached to the circumference of the image recording drum, and a head unit that ejects ink droplets of the respective colors of C, M, Y, and K to the image receiving sheet and records an image.

The head unit includes an ink jet head C that ejects an ink droplet of cyan (C) in the ink jet method, an ink jet head M that ejects an ink droplet of magenta (M) in the ink jet method, an ink jet head Y that ejects an ink droplet of yellow (Y) in the ink jet method, and an ink jet head K that ejects an ink droplet of black (K) in the ink jet method. The respective ink jet heads C, M, Y, and K are disposed in a predetermined interval along the transportation path of the image receiving sheet by the image recording drum.

The respective ink jet heads C, M, Y, and K include line heads and are formed in a length corresponding to the maximum width of the image receiving sheet. The respective ink jet heads C, M, Y, and K are disposed such that the nozzle surface (surface on which nozzles are arranged) faces the circumference of the image recording drum.

The respective ink jet heads C, M, Y, and K record an image on the image receiving layer of the image receiving sheet transported by the image recording drum by ejecting liquid droplets of the ink from the nozzles formed on the nozzle surface to the image recording drum.

### Ink Drying Treatment Unit

The ink drying treatment unit performs a drying treatment on the image receiving sheet after image recording and removes liquid components (mainly, water) remaining in the image receiving layer of the image receiving sheet. The ink drying treatment unit includes a transporting unit that transports an image receiving sheet to which an image is recorded and an ink drying treatment unit that perform a drying treatment on the image receiving sheet transported by the transporting unit.

The ink drying treatment unit is provided inside of the transporting unit and performs a drying treatment to an image receiving sheet transported through a first horizontal transportation path A. This ink drying treatment unit performs a drying treatment by blowing hot air to the surface of the image receiving layer of the image receiving sheet transported through the first horizontal transportation path A. A plurality of ink drying treatment units are disposed along the first horizontal transportation path A. The number of the disposition is set corresponding to the processing capacity of the ink drying treatment unit and the transportation speed (=printing speed) of the image receiving sheet. That is, the number is set such that the image receiving sheet can be dried while the image receiving sheet received from the image recording unit is transported through the first horizontal transportation path A. Accordingly, the length of the first horizontal transportation path A is also set considering the capacity of the ink drying treatment unit.

The humidity of the ink drying treatment unit increases by performing the drying treatment. In a case where the humidity increases, the drying treatment may not be performed effectively. Therefore, it is preferable that the humid air generated by the drying treatment is forcibly exhausted by providing the ink drying processing unit and the exhaust means in the ink drying treatment unit. For example, the exhaust means may have a configuration, for example, in which an exhaust duct is provided in the ink drying treatment unit, and the air in the ink drying treatment unit is exhausted by the exhaust duct.

The image receiving sheet received from the image recording drum of the image recording unit is received in the transporting unit. The transporting unit grips the leading end of the image receiving sheet with a gripper D and transports the image receiving sheet along a planar guide plate. The image receiving sheet received in the transporting unit is first transported through the first horizontal transportation path A. The image receiving sheet in the course of being transported through the first horizontal transportation path A is subjected to the drying treatment by the ink drying treatment unit disposed inside the transporting unit. That is, the hot air is blown to the image receiving layer of the image receiving sheet, and the drying treatment is performed in the condition in which the surface temperature of the image receiving layer becomes 30° C. or greater.

In the ink drying treatment unit, the ink fixing treatment can be performed together with the drying treatment. The ink fixing treatment is performed by blowing hot air to the image receiving layer of the image receiving sheet transported through the first horizontal transportation path in the same manner as in the drying treatment. The ink fixing treatment is performed in the condition in which the surface temperature of the image receiving layer becomes 30° C. or greater.

### Discharging Unit

The discharging unit discharges and collects the image receiving sheet subjected to the series of the image recording treatment. This discharging unit mainly includes a transporting unit that transports the image receiving sheet and a discharge table that collects the image receiving sheet in a stacked manner.

### EXAMPLES

The present invention is specifically described with reference to examples, but the scope of the present invention is not limited to the examples provided below.

### Example 1

Coating solutions having the following compositions were prepared for forming respective layers.

[Coating solution for forming image receiving layer]

| | | |
|---|---|---|
| Water | 420 | parts by mass |
| Polyolefin emulsion (ARROWBASE (registered trademark) SE1013N, Unitika Ltd., | 268 | parts by mass |
| solid content: 20 mass %) | | |
| Acryl emulsion (AQUABRID (registered trademark) AS563, Daicell Finechem Ltd., | 140 | parts by mass |
| solid content: 28 mass %) | | |
| Oxazoline crosslinking agent (EPOCROS (registered trademark) WS700, Nippon | 168 | parts by mass |
| Shokubai Co., Ltd., solid content: 25 mass %) | | |
| Surfactant (sodium = 1.2-{bis(3,3,4,4,5,5,6,6,6-nanofluorohexylcarbonyl)} | 4.3 | parts by mass |
| ethanesulfonate, solid content: 2 mass %) | | |

[Coating solution for forming antistatic layer]

| | | |
|---|---|---|
| Water | 491 | parts by mass |
| Polyolefin emulsion (ARROWBASE (registered trademark) SE1013N, Unitika Ltd., | 169 | parts by mass |
| solid content: 20 mass %) | | |
| Acryl emulsion (AQUABRID (registered trademark) AS563, Daicell Finechem Ltd., | 30 | parts by mass |
| solid content: 28 mass %) | | |
| Oxazoline crosslinking agent (EPOCROS (registered trademark) WS700, Nippon | 43 | parts by mass |
| Shokubai Co., Ltd., solid content: 25 mass %) | | |
| Surfactant (sodium = 1.2-{bis(3,3,4,4,5,5,6,6,6-nanofluorohexylcarbonyl)} | 2.4 | parts by mass |
| ethanesulfonate solid content: 2 mass %) | | |
| Surfactant (NAROACTY (registered trademark) CL95, Sanyo Chemical Industries, | 10 | parts by mass |
| Ltd., solid content: 1 mass %) | | |
| Conductive particles (FS-10D (product name), Ishihara Sangyo Kaisha, Ltd., solid | 255 | parts by mass |
| content: 17 mass %, Sb doped acicular SnO₂ aqueous dispersion) | | |

[Coating solution for forming back surface side antistatic layer]

| | | |
|---|---|---|
| Water | 666 | parts by mass |
| Acryl emulsion (JURYMER (registered trademark) ET410, Nihon Junyaku Co., | 19 | parts by mass |
| Ltd.) | | |
| Conductive particles (TDL-1 (product name), Tin oxide-antimony oxide dispersion, | 181 | parts by mass |
| JEMCO Inc., solid content: 17 mass %) | | |
| Carbodiimide crosslinking agent (CARBODILITE (registered trademark) V-02-L2, | 18 | parts by mass |
| Nisshinbo Holdings Inc., solid content: 10 mass %) | | |
| Surfactant (SANDET (registered trademark) BL, Sanyo Chemical Industries, Ltd., | 6 | parts by mass |
| solid content: 10 mass %) | | |
| Surfactant (sodium = 1.2-{bis(3,3,4,4,5,5,6,6,6-nanofluorohexylcarbonyl)} | 88 | parts by mass |
| ethanesulfonate, solid content: 0.1 mass %) | | |
| Surfactant (NAROACTY (registered trademark) CL-95, Sanyo Chemical Industries, | 12 | parts by mass |
| Ltd., solid content: 5 mass %) | | |

[Coating solution for forming back surface side flattening layer]

| | | |
|---|---|---|
| Water | 707 | parts by mass |
| Polyolefin emulsion (CHEMIPERAL (registered trademark) S120, Mitsui | 23 | parts by mass |
| Chemicals, Inc., solid content: 27 mass %) | | |
| Epoxy crosslinking agent (DENACOL (registered trademark) EX614B, Nagase | 222 | parts by mass |
| ChemteX Corporation, solid content: 1 mass %) | | |
| Surfactant (SANDET (registered trademark) BL, Sanyo Chemical Industries, Ltd., | 8 | parts by mass |
| solid content: 10 mass %) | | |
| Polystyrene sulfonic acid Na (solid content: 3 mass %) | 11 | parts by mass |
| Surfactant (NAROACTY (registered trademark) CL95, Sanyo Chemical Industries, | 14 | parts by mass |
| Ltd., solid content: 1 mass %) | | |
| Colloidal silica (SNOWTEX (registered trademark) C, Nissan Chemical Industries, | 15 | parts by mass |
| Ltd., solid content: 20 mass %) | | |

### [Manufacturing of Image Receiving Sheet]

One side of a transparent biaxially stretched PET support (hereinafter, also referred to as a transparent PET film or a transparent PET) having a thickness of 100 μm was coated with the coating solution for forming the image receiving layer by 34 mL/m², and the coating solution was dried at 150° C., to form an image receiving layer. The image receiving layer was further coated with the coating solution for forming the antistatic layer at 3.7 mL/m² and was dried at 150° C. to form an antistatic layer.

Meanwhile, a surface (that is, a back surface) on a back surface side of the transparent PET film was coated with the coating solution for forming the back surface side antistatic layer at 7.1 mL/m² and the coating solution was dried at 150° C. Coating was further performed with the coating solution for forming the back surface side flattening layer at 5.7 mL/m², and the coating solution was dried at 150° C.

Accordingly, the image receiving sheet was completed.

### (Thickness)

The cut surface of the obtained image receiving sheet in the thickness direction was observed by an electron microscope, and thickness of the respective layers was measured as follows.

Image receiving layer: 4 μm

Antistatic layer (image receiving layer side): 0.2 μm

Back surface side antistatic layer: 0.1 μm

Back surface side flattening layer: 0.05 μm

### (Surface Resistivity)

The surface resistivity on the image receiving layer side and the back surface side of the obtained image receiving sheet was measured under the environment of 25° C. and 20% RH. Specifically, a digital electrometer (8252, manufactured by ADC Corporation) and RESISTIVITY CHAMBER (12704A, manufactured by ADC Corporation) were used, and 100 V was applied, so as to calculate surface resistivity (SR) from a current value after 60 seconds.

The Logarithm (Log SR) of the surface resistivity on the image receiving layer side was 8.6, and Log SR on the back surface side was 8.2.

### Example 2

An image receiving sheet was completed in the same manner as in Example 1 except for causing the solid content concentration of the coating solution for forming the image receiving layer in Example 1 to be two times.

### Example 3

An image receiving sheet was completed in the same manner as in Example 1 except for causing a coating amount of the coating solution for forming the image receiving layer in Example 1 to be 17 mL/m².

### Example 4

An image receiving sheet was completed in the same manner as in Example 1 except for changing an addition amount of the conductive particles of the coating solution for forming the antistatic layer in Example 1 to be 146 parts by mass and an addition amount of water to be 600 parts by mass.

### Example 5

16 mass % of titanium oxide (PF739 (product name), Ishihara Sangyo Kaisha, Ltd.) was formulated as a white pigment, so as to prepare a biaxially stretched white PET support (hereinafter, also referred to as a white PET film or a white PET) having a thickness of 100 μm. The glossiness (60°) of the PET film was 99.

An image receiving layer and an antistatic layer were provided on both surfaces of the obtained white PET film in the same manner as in Example 1 to complete an image receiving sheet. The glossiness (60°) of the image receiving sheet was 94.

### Example 6

An image receiving sheet was completed in the same manner as in Example 1 except for causing the coating solution for forming the antistatic layer in Example 1 to be the following composition.

| | | |
|---|---|---|
| Water | 730 | parts by mass |
| Polyolefin emulsion (ARROWBASE (registered | 15 | parts by mass |
| trademark) SE1013N, Unitika Ltd., solid content: | | |
| 20 mass %) | | |
| Acryl emulsion (AQUABRID (registered | 10 | parts by mass |
| trademark) AS563, Daicell Finechem Ltd., | | |
| solid content: 28 mass %) | | |
| Oxazoline crosslinking agent (EPOCROS | 22 | parts by mass |
| (registered trademark) WS700, Nippon Shokubai | | |
| Co., Ltd., solid content: 8 mass %) | | |
| Conductive particles (TDL-1 (product name), | 181 | parts by mass |
| a tin oxide-antimony oxide dispersion | | |
| (an aqueous dispersion of Sb-doped | | |
| granular SnO₂), JEMCO Inc., | | |
| solid content: 17 mass %) | | |
| Surfactant (SANDET (registered trademark) BL, | 21 | parts by mass |
| Sanyo Chemical Industries, Ltd., | | |
| solid content: 3 mass %) | | |
| Surfactant (NAROACTY (registered trademark) | 21 | parts by mass |
| CL-95, Sanyo Chemical Industries, Ltd., | | |
| solid content: 3 mass %) | | |

### Example 7

An image receiving sheet was completed in the same manner as in Example 1 except for causing the coating solution for forming the antistatic layer in Example 1 to be the following composition.

| | | |
|---|---|---|
| Water | 826 | parts by mass |
| Polyolefin emulsion (ARROWBASE (registered | 16 | parts by mass |
| trademark) SE1013N, Unitika Ltd., | | |
| solid content: 20 mass %) | | |
| Acryl emulsion (AQUABRID (registered | 8 | parts by mass |
| trademark) AS563, Daicell Finechem Ltd., solid | | |
| content: 28 mass %) | | |
| Oxazoline crosslinking agent (EPOCROS | 3 | parts by mass |
| (registered trademark) WS700, Nippon | | |
| Shokubai Co., Ltd., solid content: | | |
| 25 mass %) | | |
| Colloidal silica (SNOWTEX (registered | 5 | parts by mass |
| trademark) C, Nissan Chemical Industries, Ltd., | | |
| solid content: 20 mass %) | | |
| Carnauba wax (SELOSOL (registered trademark) | 8 | parts by mass |
| 524, Chukyo Yushi Co., Ltd., solid content: | | |
| 3 mass %) | | |
| Conductive polymer (Orgacon (registered | 66 | parts by mass |
| trademark) HBS, Agfa Materials Corporation, | | |
| solid content: 1.2 mass %, polyethylene | | |
| dioxythiophene (PEDOT)/polystyrene | | |
| sulfonate (PSS)) | | |
| Surfactant (NAROACTY (registered trademark) | 68 | parts by mass |
| CL95, Sanyo Chemical Industries, Ltd., | | |
| solid content: 1 mass %) | | |

### Comparative Example 1

An image receiving sheet was completed in the same manner as in Example 1 except for causing the thickness of the image receiving layer in Example 1 to be 0.5 μm.

### Comparative Example 2

An image receiving sheet was completed in the same manner as in Example 1 except for not adding conductive particles in the preparation of the coating solution for forming the antistatic layer in Example 1.

### Comparative Example 3

An image receiving sheet was completed in the same manner as in Example 1 of JP1999-84707A (JP-H11-84707A).

### <Evaluation of Electrophotographic Image Receiving Sheet>

### [Accumulation Properties]

10 sample color images were continuously formed on DC1450GA and Color1000 (manufactured by Fuji Xerox Co., Ltd.) by using each of the image receiving sheets prepared in each of the examples.

Thereafter, the degree of bonding of 10 samples discharged from each printing machine due to static electricity was evaluated on whether edges of the image receiving sheets were able to be aligned with hands.

A: Good (edges were able to be aligned in the same way as before image formation.)

B: Acceptable (slight bonding was observed, but edges were able to be aligned.)

C: Not acceptable (edges were bonded and were not able to be aligned.)

### [Fixing Properties]

One sample color image was formed with DC1450GA and Color1000 (manufactured by Fuji Xerox Co., Ltd.) by using each of the image receiving sheets prepared in each example, and the image was rubbed with a nail.

G: Images on both sheets were not peeled off.

NG: An image on at least one sheet was peeled off.

Main compositions and evaluation results of the support, the image receiving layer, and the antistatic layer are presented in Table 1. With respect to the surface resistivity on the image receiving layer side, logarithm is taken and written as Log SR.

TABLE 1

| | | Image | | | | | | |
|---|---|---|---|---|---|---|---|---|
| | | receiving | | | | | | |
| | | layer | Antistatic layer | | | Evaluation | | |
| | Support | Thickness | Thickness | | | Accumulation | Fixing | Log |
| | Kind | (μm) | (μm) | Conductive material | Resin | properties | properties | SR |
| Example 1 | Transparent | 4 | 0.2 | Acicular SnO₂ | Polyolefin/acryl | A | G | 8.6 |
| | PET | | | (Sb doped) | | | | |
| Example 2 | Transparent | 8 | 0.2 | Acicular SnO₂ | Polyolefin/acryl | A | G | 8.6 |
| | PET | | | (Sb doped) | | | | |
| Example 3 | Transparent | 2 | 0.2 | Acicular SnO₂ | Polyolefin/acryl | A | G | 8.6 |
| | PET | | | (Sb doped) | | | | |
| Example 4 | Transparent | 4 | 0.2 | Acicular SnO₂ | Polyolefin/acryl | B | G | 9.5 |
| | PET | | | (Sb doped) | | | | |
| Example 5 | White PET | 4 | 0.2 | Acicular SnO₂ | Polyolefin/acryl | A | G | 8.6 |
| | | | | (Sb doped) | | | | |
| Example 6 | Transparent | 4 | 0.1 | Acicular SnO₂ | Polyolefin/acryl | A | G | 8.2 |
| | PET | | | (Sb doped) | | | | |
| Example 7 | Transparent | 4 | 0.05 | PEDOT/PSS | Polyolefin/acryl | A | G | 8.6 |
| | PET | | | | | | | |
| Comparative | Transparent | 0.5 | 0.2 | Acicular SnO₂ | Polyolefin/acryl | A | NG | 8.6 |
| Example 1 | PET | | | (Sb doped) | | | | |
| Comparative | Transparent | 4 | 0.2 | None | Polyolefin/acryl | C | G | 15 |
| Example 2 | PET | | | | | | | |
| Comparative | Transparent | 0.25 | 2 | Au plated | Polyester | C | G | 12 |
| Example 3 | PET | | | polystyrene | | | | |

As presented in Table 1, all of the image receiving sheets of the examples had excellent accumulation properties and excellent fixing properties compared with the image receiving sheets of the comparative examples. Particularly, in Examples 1 and 4, the surface resistivity varied depending on the difference of the content of the conductive material in the antistatic layer, but together with Example 1, in the examples in which Log SR was 9.0 or less, accumulation properties were excellent compared with Example 4 having Log SR of 9.5.

### <Evaluation as Ink Jet Printing Image Receiving Sheet>

### (Preparation of Cyan Ink)

A solution obtained by mixing components presented in the following composition of cyan ink was stirred at room temperature at 5,000 rpm for 20 minutes by using a mixer (manufactured by Silverson Machines, Inc., L4R), so as to prepare cyan ink.

The viscosity of the prepared cyan ink was measured by using VISCOMETER TV-22 (manufactured by TOKI SANGYO CO. LTD.) and was 6 mPa·s at 30° C.

The surface tension of the prepared cyan ink was measured by using Automatic Surface Tensiometer CBVP-Z (manufactured by Kyowa Interface Science Co., Ltd.) and was 38 mN/m at 25° C.

The viscosity and the surface tension of the other ink were measured in the same manner as in cyan ink.

-Composition of cyan ink-

| | | |
|---|---|---|
| Cyan pigment dispersion | 18 | mass % |
| (dispersion of colorant, Projet Cyan APD 3000, | | |
| manufactured by FUJIFILM Imaging Colorants, | | |
| Inc., pigment concentration: 14 mass %) | | |
| Glycerin | 8 | mass % |
| (water soluble high-boiling point solvent, | | |
| manufactured by Wako Pure Chemical | | |
| Industries, Ltd., boiling point: 290° C.) | | |
| Polyethylene glycol monomethyl ether | 8 | mass % |
| (Water soluble high-boiling point solvent, HI-MOL | | |
| PM manufactured by Toho Chemical Industry Co., | | |
| Ltd., boiling point: 290° C. to 310° C.) | | |
| OLFINE (registered trademark) E1010 | 0.3 | mass % |
| (manufactured by Nissin Chemical Co., Ltd., | | |
| surfactant) | | |
| Self dispersibility polymer particles P-1 | 8 | mass % |
| (Resin particles) | | |
| PVP K-15 | 0.2 | mass % |
| (manufactured by ISB Corporation) | | |
| Urea | 5 | mass % |
| SELOSOL 524 | 3 | mass % |
| (manufactured by Chukyo Yushi Co., Ltd.) | | |
| Lithium chloride | 0.01 | mass % |
| SNOWTEX (registered trademark) XS | 0.3 | mass % |
| (colloidal silica, Nissan Chemical Industries, Ltd.) | | |
| CAPSTONE (registered trademark) FS-63 | 0.01 | mass % |
| (Surfactant, manufactured by Dupont) | | |
| BYK (registered trademark)-024 | 0.01 | mass % |
| (Anti-foaming agent, manufactured by BYK Japan | | |
| K.K.) | | |

| | |
|---|---|
| Ion exchange water | A remaining amount |
| | to be 100 mass % |
| | in total |

### (Preparation of Magenta Ink, Yellow Ink, and Black Ink)

Magenta ink, yellow ink, and black ink were prepared in the same manner except for changing the cyan pigment dispersion used in the preparation of the cyan ink to the kind and amount of the pigment dispersion shown below.

The viscosity of the prepared magenta ink was 6 mPa·s, and the surface tension thereof was 38 mN/m.

The viscosity of the prepared yellow ink was 6 mPa·s, and the surface tension thereof was 38 mN/m.

The viscosity of the prepared black ink was 6 mPa·s, and the surface tension thereof was 38 mN/m.

Magenta ink

| | |
|---|---|
| Magenta pigment dispersion | 40 mass % |
| (Dispersion of colorant, Projet Magenta APD 3000, | |
| manufactured by FUJIFILM Imaging Colorants, | |
| Inc., pigment concentration: 14 mass %) | |

Yellow ink

| | |
|---|---|
| Yellow pigment dispersion | 25 mass % |
| (Dispersion of colorant, Projet Yellow APD 3000, | |
| manufactured by FUJIFILM Imaging Colorants, | |
| Inc., pigment concentration: 14 mass %) | |

Black ink

| | |
|---|---|
| Black pigment dispersion | 21 mass % |
| (Dispersion of colorant, Projet Black APD 3000, | |
| manufactured by FUJIFILM Imaging Colorants, | |
| Inc., pigment concentration: 14 mass %) | |

### (Image Forming Condition)

Jet Press (registered trademark) 720 manufactured by Fujifilm Corporation was used as a printer. Specification and printing conditions of Jet Press (registered trademark) 720 were provided below.
Drawing method: Single pass drawing
Image formation speed: 2,880 sheets/hr (linear velocity: 30 m/min)
Resolution: 1,200 dpi×1,200 dpi
Ink liquid droplet volume

Small droplet: 2 pl, medium droplet: 7 pl, large droplet: 10 pl
Printing system impression cylinder transporting system: 1) An image recording unit and 2) an ink drying processing unit were respectively arranged from the upstream on three impression cylinders. The order of each step is 1) image recording→2) drying and fixing•drying conditions from the upstream.

Body temperature: 70° C., hot air and carbon heater: 70° C., image receiving layer surface temperature: 50° C.
Fixing temperature

Body temperature: 45° C., hot air: 70° C., image receiving layer surface temperature: 50° C.
Use material

Aqueous ink: yellow ink, magenta ink, cyan ink, and black ink described above

Yellow ink, magenta ink, cyan ink, and black ink were ejected to the image receiving layer of the image receiving sheet through JetPress (registered trademark) RIP (Raster image processor) XMF (manufactured by Fujifilm Corporation) by using the above device, and were dried in the above drying conditions. In this manner, a printed matter on which an image was formed on the image receiving layer of the image receiving sheet having a size of 636 mm×469 mm was obtained.

In a case where the ink passed through RIP of JetPress (registered trademark), a small droplet was used on the low concentration side, and the middle droplet ratio was increased as the concentration was increased.

### (Evaluation)

Ink jet images were formed on the respective image receiving sheets prepared in Examples 1 and 5 under the above image forming conditions. With respect to the image receiving sheet after the image formation, the accumulation properties and the fixing properties were evaluated by the same evaluation method and the same evaluation standards as the evaluation of electrophotographic image receiving sheet. As a result, in all of the image receiving sheets, accumulation properties were evaluated as “A”, and fixing properties were evaluated as “G”.

The disclosure of JP2015-112629, filed Jun. 2, 2015, is hereby incorporated by reference in its entirety.

All documents, patent applications, and technical standards described in this specification are hereby incorporated by reference to the same extent as if each individual document, patent application, and technical specification were specifically and individually indicated to be incorporated by reference in the present specification.

What is claimed is:

1. An image receiving sheet comprising, on at least one surface of a support, in an order from the support side:
an image receiving layer including a resin and having a thickness of 1 μm or greater; and
an antistatic layer being the outermost layer, including a resin and at least one conductive material selected from conductive particles and a conductive polymer and having a thickness smaller than that of the image receiving layer.

2. The image receiving sheet according to claim 1,
wherein the image receiving layer and the antistatic layer each include at least one resin selected from an acrylic resin, a urethane resin, a polyester resin, and a polyolefin resin as the resin and have a crosslinking structure derived from at least one crosslinking agent selected from an oxazoline crosslinking agent, an epoxy crosslinking agent, a carbodiimide crosslinking agent, and an isocyanate crosslinking agent.

3. The image receiving sheet according to claim 1,
wherein the antistatic layer includes at least a polyolefin resin as the resin, and a content of the polyolefin resin is the largest among the resins included in the antistatic layer.

4. The image receiving sheet according to claim 1,
wherein surface resistivity on a side including the image receiving layer and the antistatic layer is 10⁷ to 10¹⁰ Ω/sq.

5. The image receiving sheet according to claim 1,
wherein a thickness of the image receiving layer is 1 to 10 μm, and a thickness of the antistatic layer is 0.01 to 1 μm.

6. The image receiving sheet according to claim 1,
wherein the support is a polyethylene terephthalate film.

7. The image receiving sheet according to claim 1,
wherein the antistatic layer includes acicular particles obtained by doping SnO₂ with Sb as the conductive material.

8. The image receiving sheet according to claim 1,
wherein the image receiving layer does not include the conductive material, or a content of the conductive material included per unit volume of the image receiving layer is smaller than that of the conductive material included per unit volume of the antistatic layer.

9. The image receiving sheet according to claim 1 which is used for electrophotography.

10. The image receiving sheet according to claim 1 which is used for ink jet printing.
